(19) United States
(12) Patent Application Publication
(10) Pub. No.: US 2007/0180452 A1
(43) Pub. Date: Aug. 2, 2007

(54) Load distributing system and method

(76) Inventors: Hideaki Hirayama, Kawasaki-shi (JP); Kenichi Mizoguchi, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/558,237

(22) PCT Filed: May 26, 2004
(86) PCT No.: PCT/JP04/07558

§ 371 Date: Nov. 3, 2006

(30) Foreign Application Priority Data
May 26, 2003 (JP) 2003-148233

(51) Int. Cl. G06F 9/46

(52) U.S. Cl. 718/105

(57) ABSTRACT

Based on the load of all load distribution target computers including Web server computers (11-1 to 11-6), a server configuration management unit (151) determines the number of provisioning node (PN) computers, use of which as load distribution target computers is to be started, or use of which as load distribution target computers is to be ended. A PN management unit (152) determines computers, the use of which is to be started or ended. The determined computers are included in PN computers (15-1 to 15-4). A PN start/stop unit (153) starts or stops the determined computers. A setting change unit (154) controls a load distributing device (12) so that the determined computers are included in or excluded from target computers of load distribution by the load distributing device (12).

### TECHNICAL FIELD

The present invention relates to a load distributing system for distributing the load of requests, received from a plurality of client computers, by distributing them between a plurality of computers. More particularly, it relates to a load distributing system and method suitable for dealing with a sudden spike state.

### BACKGROUND ART

A load distributing system is known which distributes execution requests, issued from a large number of client computers, between a plurality of computers, to efficiently process them. This type of load distributing system is described in, for example, R. Buyya, “High Performance Cluster Computing: Architecture and Systems (Volume 1 & 2)”, 1999, Prentice Hall, or Tony Bourke, “Server Load distributing Technique”, O'Reilly Japan Co., Ltd., Dec. 13, 2001. A load distributing system, for example, a Web server load distributing system comprises a plurality of Web server computers and a load distributing device.

In the Web server load distributing system, a request (execution request) from a client computer is sent to the load distributing device via an external network. This request is issued by, for example, a Web browser running on the client computer. Upon receiving the request from the client computer, the load distributing device selects, from the Web server computers, one server computer that should process the request. The server selection is performed so that excessive load will be prevented from being applied to only a particular server computer. Accordingly, server selection is performed using, for example, (1) a round robin method, (2) a weighted round robin method, or (3) a method for selecting a server computer that has a minimum number of sessions at present. The round robin method is a method for equally selecting all server computers one by one in order. The weighted round method is a method based on the round robin method, but in this method, the frequency of selection of each server computer is changed in accordance with the capacity of each computer.

The load distributing device sends the received request to the selected server computer via an internal network. On the selected server computer, a Web server is running. Based on the received request, the server computer performs processing using the Web server. After that, the server computer supplies the load distributing device with a reply to the request via the internal network. The load distributing device, in turn, sends the reply to the client computer as the request sender via the external network.

Further, Tetsuo Kaneko and Yoshiya Mori, “Cluster Software”, Toshiba Review, vol. 54, No. 12 (1999), pp. 18-21 (hereinafter referred to as “the prior art document”) describe a computer system called a cluster system. In the cluster system, when a failure has occurred in a certain computer in operation, the service (business operation) executed immediately before the occurrence of the failure is taken over to another computer included in the system (fail-over is executed). For example, a computer in a standby state (hot standby state) is used as the fail-over computer.

In the above-described Web server load distributing system including Web servers, the number of Web servers used to process requests from client servers is generally determined based on, for example, the number of requests. Recently, however, the number of users of the Internet has becomes enormous. Accordingly, a much greater number of requests than that the Web-site managing operators expect are liable to concentrate on the-load distributing system. In this case, the following troubles due to a so-called “spike phenomenon” will often occur:

(A) An extremely long response time may be required for each request;

(B) Access to the Web servers may become impossible; and

(C) The Web servers may be down.

When the Web-site operators can estimate an increase in the number of requests (the number of hits) to a certain degree, they can deal with the spike phenomenon, for example, using additional Web servers. However, in most cases, it is impossible to estimate an increase in the number of hits, which makes it difficult to deal with the phenomenon.

### DISCLOSURE OF INVENTION

It is an object of the invention to provide a load distributing system capable of easily dealing with a sudden spike phenomenon, and a load distributing method employed therein.

In accordance with an aspect of the invention, there is provided a load distributing system comprising a plurality of server computers, a load distributing device, a plurality of provisioning computers, a provisioning-computer management unit, a provisioning-computer start/stop unit and a boot-image selection unit. The server computers processes requests from a plurality of client computers. The server computers are managed, classified into a plurality of server computer groups corresponding to different types of boot images, the different types of boot images including operating systems executed by the server computers. The load distributing device is configured to distribute the requests from the client computers between a plurality of load distribution target computers including the server computers. The provisioning computers is usable as load distribution target computers. The provisioning computers is started when the provisioning computers are used as the load distribution target computers. The server configuration management unit is configured to determine, for each server computer group, the number of provisioning computers, the use of which as new load distribution target computers is to be started, or the use of which as load distribution target computers is to be ended, based on a load of all load distribution target computers including the server computers of said each server computer group. The provisioning-computer management unit is configured to manage states of use of the provisioning computers. The provisioning computer management unit determines provisioning computers corresponding to the number of provisioning computers determined by the server configuration management unit for said each server computer group, the use of the corresponding provisioning computers as the new load distribution target computers being to be started, or the use of the corresponding provisioning computers as the load distribution target computers being to be ended. The provisioning-computer start/stop unit is configured to start or stop the provisioning computers determined by the provisioning-computer management unit. The setting change unit is configured to add, as load distribution target computers that are targets of load distribution by the load distributing device, the provisioning computers determined by the provisioning-computer management unit, or to exclude, from load distribution target computers that are targets of load distribution by the load distributing device, the provisioning computers determined by the provisioning-computer management unit. The boot-image selection unit is configured to select, from the different types of boot images, a boot image corresponding to said each server computer group which includes the provisioning computers determined by the provisioning-computer management unit and started to be used as the load distribution target computers. The boot image is used to boot the provisioning computers determined by the provisioning-computer management unit.

### BRIEF DESCRIPTION OF DRAWINGS

FIG. 1 is a block diagram illustrating the configuration of a load distributing system according to a first embodiment of the invention;

FIG. 2 is a flowchart illustrating the operation procedure of the first embodiment;

FIG. 3 is a block diagram illustrating the configuration of a load distributing system according to a second embodiment of the invention;

FIG. 4 is a flowchart illustrating the operation procedure of the second embodiment;

FIG. 5 is a view illustrating a data structure example of the table 151a appearing in FIG. 1;

FIG. 6 is a view illustrating a data structure example of the table 251a appearing in FIG. 3;

FIG. 7 is a block diagram illustrating the configuration of a load distributing system according to a third embodiment of the invention;

FIG. 8 is a flowchart illustrating the operation procedure of the third embodiment;

FIG. 9 is a block diagram illustrating the configuration of a load distributing system according to a fourth embodiment of the invention;

FIG. 10 is a flowchart illustrating the operation procedure of the fourth embodiment;

FIG. 11 is a view illustrating a data structure example of the table 351a appearing in FIG. 7;

FIG. 12 is a view illustrating a data structure example of the table 451a appearing in FIG. 9;

FIG. 13 is a view illustrating a data structure example of the table 470 appearing in FIG. 9;

FIG. 14 is a view illustrating a state in which identifiers (P1 and P2) for provisioning node computers 15-1 and 15-2 are additionally stored in the table 470 in the state of FIG. 13 in relation to an identifier (D1) for a disk D1;

FIG. 15 is a block diagram illustrating a modification of the fourth embodiment of the invention;

FIG. 16 is a block diagram illustrating the configuration of a load distributing system according to a fifth embodiment of the invention;

FIG. 17 is a flowchart illustrating the operation procedure of a Web server site in the fifth embodiment;

FIG. 18 is a flowchart illustrating the operation procedure of a common provisioning node computer site in the fifth embodiment; and

FIG. 19 is a view a data structure example of the record file 652a appearing in FIG. 16.

### BEST MODE FOR CARRYING OUT THE INVENTION

Embodiments of the invention will be described with reference to the drawings.

### FIRST EMBODIMENT

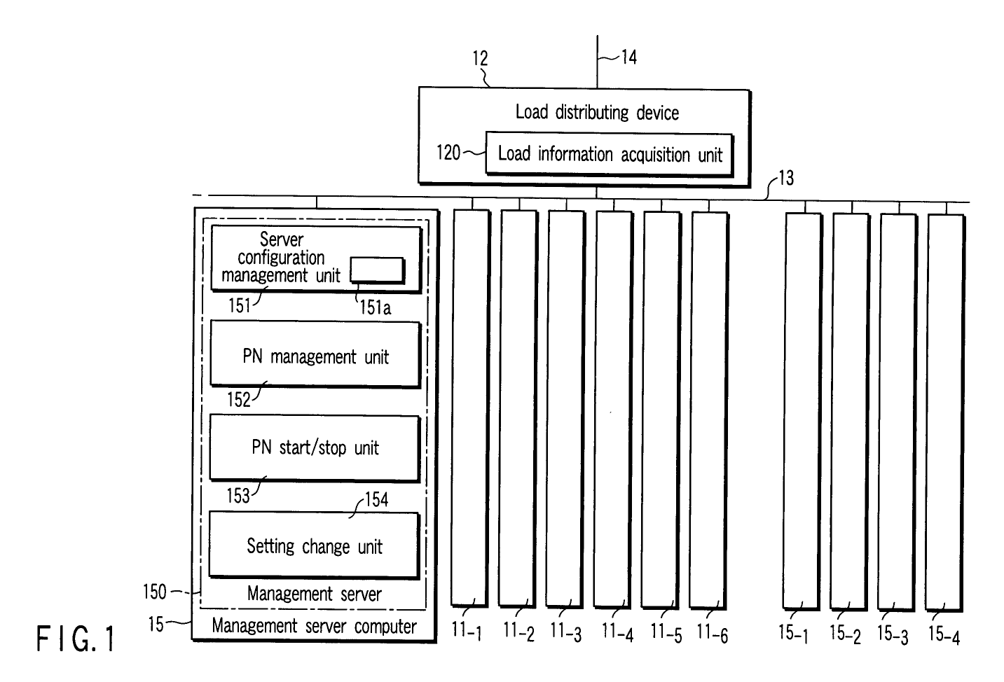

FIG. 1 is a block diagram illustrating the configuration of a load distributing system according to a first embodiment of the invention. The system of FIG. 1 comprises a plurality (e.g., six) of Web server computers 11-1 to 11-6 and a load distributing device 12. The Web server computers 11-1 to 11-6 and load distributing device 12 are connected to each other via a network (internal network) 13 incorporated in the system. Further, the load distributing device 12 is connected to a plurality of client computers (not shown) via a network (external network) 14 that is not incorporated in the system.

The Web server computers 11-1 to 11-6 process requests from client computers. When a request is received from a client computer via the external network 14, the load distributing device 12 selects one server computer from the Web server computers 11-1 to 11-6 to cause it to process the request. For selection, any one of the selection methods (1) to (3) described in the background art can be utilized. Further, the load distributing device 12 transmits the request from the client computer to the selected server computer. Namely, the load distributing device 12 distributes, to the Web server computers 11-1 to 11-6, requests supplied from a large number of client computers, to distribute the load therebetween.

The load distributing device 12 includes a load information acquisition unit 120. The load information acquisition unit 120 acquires information (computer load information) indicating the loaded state of each computer as a target of load distributing by the load distributing device 12. The number of sessions set by the load distributing device 12 between the device 12 and the load distribution target computer is used as the load information concerning a computer as a load distribution target, acquired by the device 12. The load distribution target computer is any one of the Web server computers 11-1 to 11-6 and provisioning node computers 15-1 to 15-4 described below, which is booted as a load distribution target.

The provisioning node computers (hereinafter referred to as “the PN computers”) 15-1 to 15-4 are auxiliary computers that are usually in the OFF state and not booted. The PN computers 15-1 to 15-4 are placed as load distribution target candidates for eliminating a sudden “spike state”. However, any PN computer that is already used as a load distribution target is removed from the candidates. In this embodiment, the “spike state” is regarded as a state in which the load of all computers as load distribution targets exceeds a preset threshold value. The PN computers 15-1 to 15-4 are connected to the internal network 13.

The internal network 13 is also connected to a management server computer 15. A management server 150 is running on the management server computer 15. The management server 150 is realized when a CPU (not shown) in the management server computer 15 reads and executes a preset computer management program. The computer management program is provided by a recording medium, such as a CD-ROM, flexible disk or memory card. The computer management program provided by the recording medium is stored and used in, for example, a disk drive in the management server computer 15. The computer management program may be sent to the management server computer 15 via the external network 14 and stored in the disk drive thereof.

The management server 150 includes various functional elements, such as a server configuration management unit 151, provisioning node management unit (hereinafter referred to as “the PN management unit”) 152, provisioning node start/stop unit (hereinafter referred to as “the PN start/stop unit”) 153, and setting change unit 154.

The server configuration management unit 151 has a function for managing a computer (server computer) serving as a Web server. The server configuration management unit 151 also has a function for determining the number of PN computers, the use of which should be started (i.e., which should be newly used as load distribution targets), or the use of which should be ended (i.e., which should be excluded from the load distribution targets). This determination is performed based on the load states of the computers set as load distribution targets by the load distributing device 12. To realize this, the server configuration management unit 151 holds a table 151a. The table 151a stores threshold values (load threshold values), each of which is set for the load of all load distribution target computers employed, in relation to the numbers of PN computers (the numbers of to-be-used PN computers) to be used as load distribution targets and corresponding to the respective threshold values.

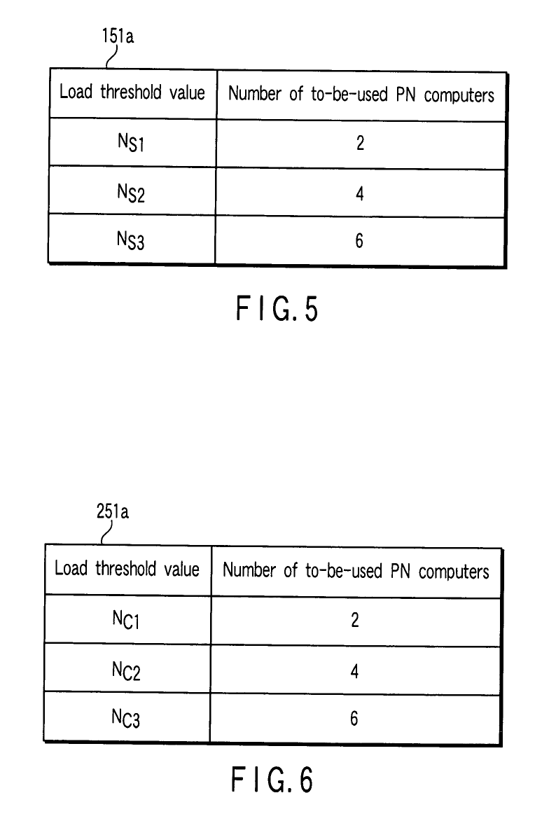

FIG. 5 shows an example of the table 151a. In the example of FIG. 5, the table 151a stores three load threshold values N_{S1}, N_{S2} and N_{S3} in relation to the respective numbers of to-be-used PN computers. The three load threshold values N_{S1}, N_{S2} and N_{S3} correspond to first, second and third spike states, respectively. The table 151a is preset in the computer management program, and is loaded to the main memory (not shown) of the management server computer 15 when the computer 15 is booted.

The PN management unit 152 has a function for managing the states of use of the PN computers 15-1 to 15-4. Further, when the server configuration management unit 151 determines the number of PN computers, the use of which should be started or ended, the PN management unit 152 determines (selects) PN computers, the use of which should be started or ended, from the PN computers 15-1 to 15-4.

The PN start/stop unit 153 has a function for starting or stopping the PN computers determined by the PN management unit 152. The PN start/stop unit 153 performs the start/stop of a PN computer in the following manners. The PN start/stop unit 153 utilizes the “Wake On LAN” (trademark) technique to start a PN computer. To start a PN computer, the PN start/stop unit 153 sends, to the internal network 13, a particular packet that designates the PN computer to start. To designate the PN computer, the particular packet includes a MAC address assigned to a LAN card (network card) mounted in the PN computer. LAN cards mounted in the respective PN computers operate as control circuits for connecting the computers to a network (in this case, the internal network 13). Each LAN card is kept in a standby state to survey particular packets transmitted through the internal network 13. To this end, a standby current is always supplied to each LAN card when the PN computers are in the OFF state. Each LAN card has a function for booting the corresponding PN computer when it receives a particular packet that designates the corresponding MAC address, namely, a particular packet addressed to it. Further, the PN start/stop unit 153 stops each PN computer in the following manner. The PN start/stop unit 153 supplies, to a PN computer to stop via the internal network 13, a shutdown command that designates interruption of power as an option. As a result of the supply of the command, the PN start/stop unit 153 stops the PN computer. More specifically, in the case of, for example, the operating system UNIX (trademark), command “init” can be used as a shutdown command. The command “init” includes an option that designates power interruption. When the shutdown command that designates power interruption is executed, a power supply driver is called to interrupt the supply of power to the computer. To execute a shutdown command from a remote computer, it is sufficient if a remote shell (rss) command is used.

The setting change unit 154 has a function for controlling the load distributing device 12 so that the device 12 makes a PN computer, started or stopped by the PN start/stop unit 153, be a load distribution target of the device 12, or excludes the PN computer from the load distribution targets. In other words, the setting change unit 154 has a function for permitting the load distributing device 12 to supply a request to a PN computer, started or stopped by the PN start/stop unit 153, or inhibiting the device 12 from supplying the request to the PN computer.

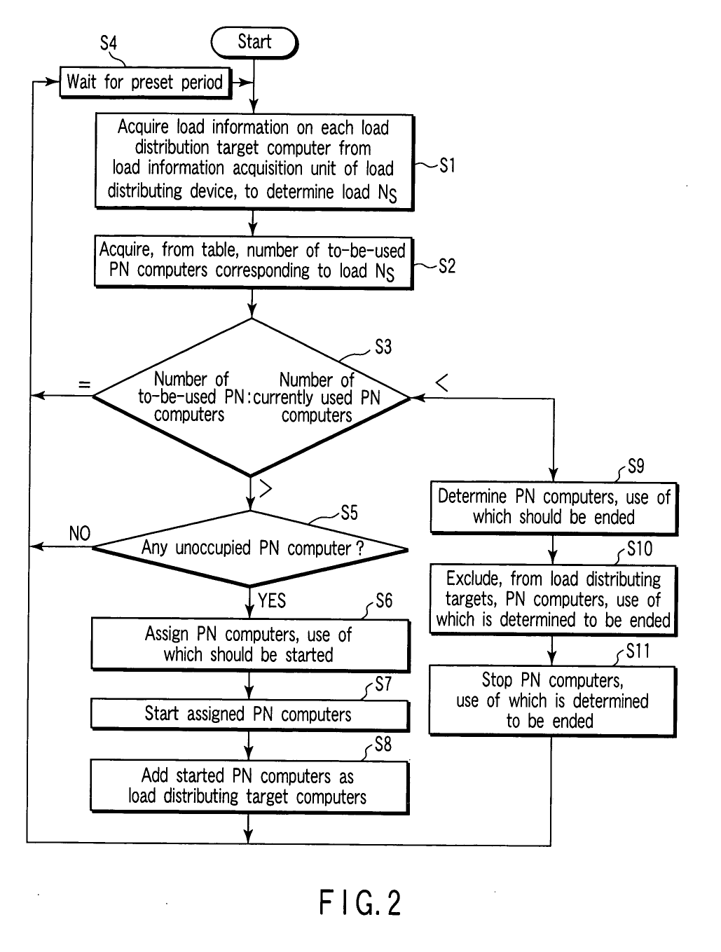

Referring then to the flowchart of FIG. 2, a description will be given of the operation of the load distributing system of FIG. 1. Firstly, the server configuration management unit 151 in the management server computer 15 acquires, from a load information acquisition unit 120 incorporated in the load distributing device 12, load information indicating the load of each of the computers (load distribution target computers) that include Web server computers 11-1 to 11-5 and serve as load distribution targets of the load distributing device 12 (step S1). Accordingly, if one or more of the PN computers 15-1 to 15-4 are used as load distribution target computers, load information concerning the one or more PN computers is also acquired. In this embodiment, the number of sessions set by the load distributing device 12 between each client computer and each load distribution target computer is acquired as computer load information corresponding to each load distribution target computer. At step S1, the server configuration management unit 151 computes the load N_{S} of all load distribution target computers from the computer load information of each load distribution target computer. In this embodiment, the entire load N_{S} can be acquired by adding up the loads (the numbers of sessions) indicated by the computer load information of all load distribution target computers. Alternatively, weighting using weights corresponding to (e.g., in inverse proportion to) the processing capacities of the load distribution target computers may be made on the loads, and the addition result of such weighted loads be used as the entire load N_{S}.

Subsequently, referring to the table 151a, the server configuration management unit 151 determines the number of to-be-used PN computers that corresponds to the present load N_{S} (step S2). In the embodiment, the contents of the table 151a are set as shown in FIG. 5. In this case, the server configuration management unit 151 determines the number of to-be-used PN computers as follows:

If N_{S}<N_{S1}, the number of to-be-used PN computers is zero;

If N_{S1}≦N_{S}<N_{S2}, the number of to-be-used PN computers is two;

If N_{S2}≦N_{S}<N_{S3}, the number of to-be-used PN computers is four; and

If N_{S}≧N_{S3}, the number of to-be-used PN computers is six.

Subsequently, the server configuration management unit 151 compares the determined number of to-be-used PN computers with the number of currently used PN computers (step S3). If they are equal to each other, the server configuration management unit 151 determines that it is not necessary to assign a new PN computer as a load distribution target computer (i.e., a computer that should be started to be used). In this case, the server configuration management unit 151 assumes a standby state for a predetermined period (step S4), and then iterates step S1 and the later steps.

In contrast, if the number of to-be-used PN computers is greater (step S3), the server configuration management unit 151 determines that it is necessary to assign a new PN computer as a load distribution target computer. In this case, the server configuration management unit 151 requests the PN management unit 152 to start the use of a new PN computer. In response to this request, the PN management unit 152 determines whether the PN computers 15-1 to 15-4 contain an unoccupied PN computer (step S5). If any unoccupied PN computer is not contained, i.e., if all the PN computers 15-1 to 15-4 are already used as load distribution target computers, this is reported from the PN management unit 152 to the server configuration management unit 151. At this time, the server configuration management unit 151 assumes the standby state for the predetermined period (step S4), and then iterates step S1 and the later steps.

In contrast, if an unoccupied PN computer is contained, i.e., if there is a PN computer that is not used (booted) at present, the PN management unit 152 performs processing for assigning the PN computer as a computer (load distribution target computer) that should be started to be used (step S6). This process is performed as below, based on whether the number N of unoccupied PN computers is larger or smaller than the difference Nd between the above numbers. Firstly, if N≧Nd, the PN management unit 152 selects, from the unoccupied PN computers, the same number of PN computers as the difference Nd, and assigns them as computers that should be started to be used. Further, if N<Nd, the server configuration management unit 151 selects all of the number N of unoccupied PN computers and assigns them as computers that should be started to be used, although they are insufficient in number. Information indicating the computer assignment is supplied from the PN management unit 152 to the server configuration management unit 151, PN start/stop unit 153 and setting change unit 154.

Upon receiving this, the PN start/stop unit 153 starts the PN computers assigned (determined) by the server configuration management unit 151 as computers that should be started to be used (step S7). At this time, the setting change unit 154 controls the load distributing device 12 to add the PN computers, started by the PN start/stop unit 153 (the start of use of the computers is determined by the PN management unit 152), as load distribution target computers that serve as the load distribution targets of the load distributing device 12 (step S8). The order of steps S7 and S8 may be reversed. When the load distribution targets of the load distributing device 12 have been changed by the control of the setting change unit 154, the server configuration management unit 151 assumes the standby state for the predetermined period (step S4), and then iterates step S1 and the later steps.

If the number of to-be-used PN computers is smaller than that of currently used PN computers (step S3), the server configuration management unit 151 determines that it is necessary to end the use of the same number of PN computers as the difference Nd. In this case, the server configuration management unit 151 requests the PN management unit 152 to finish the use of the same number of PN computers as Nd. In response to this request, the PN management unit 152 determines, from the currently used PN computers, the same number of PN computers as Nd, the use of which should be ended (step S9). Information indicating the PN computers, the end of use of which is determined by the PN management unit 152, is sent from the PN management unit 152 to the server configuration management unit 151, PN start/stop unit 153 and setting change unit 154.

At this time, the setting change unit 154 controls the load distributing device 12 so that the PN computers, the use of which is determined to be ended, will be excluded from the load distribution targets of the load distributing device 12 (step S10). The PN start/stop unit 153 stops the PN computers, the end of use of which is determined by the PN management unit 152 (step S11). The order of steps S10 and S11 may be reversed. When the same number of PN computers as Nd are stopped, the server configuration management unit 151 assumes the standby state for the predetermined period (step S4), and then iterates step S1 and the later steps.

As is apparent from the above description, in the system of FIG. 1 that employs the table 151a of FIG. 5, if the load N_{S} is not less than the load threshold value N_{S1} (provided that N_{S}<N_{S2}), two PN computers are used as load distribution target computers. In this state, if the load N_{S} is increased to the load threshold value N_{S2} or more (provided that N_{S}<N_{S3}), further two PN computers are added as load distribution target computers. In this case, four PN computers in total, i.e., all PN computers 15-1 to 15-4 in the system, are used. If in this state, the load N_{S} is increased to the load threshold value N_{S2} or more, yet two PN computers must be added as load distribution target computers. At this time, however, all PN computers 15-1 to 15-4 in the system are already used, and no more unoccupied PN computers exist. Accordingly, there is no case where more than four PN computers are used.

Further, when the PN computers 15-1 to 15-4 are used, if the load N_{S} is lower than the load threshold value N_{S2} (provided that N_{S}≧N_{S1}), two PN computers are excluded from the load distribution targets. In this case, the remaining two PN computers are used. In this state, if the load N_{S} is lower than the load threshold value N_{S1}, the remaining two PN computers are also excluded from the load distribution targets. As a result, no PN computers are used. It can be understood from this that the table 151a defines the conditions for the start/end of use of PN computers, which correspond to load.

As described above, in the load distributing system of the first embodiment of the invention, when a load causing a spike state has occurred, one or more PN computers (spare computers) are booted, and the load distributing device 12 performs load distributing additionally using the booted PN computers. In this state, if the load is reduced, the PN computers are excluded from the load distribution targets and stopped. As a result, a sudden spike state can be dealt with even if a large number of servers are not booted at all times. Namely, even if a much greater number of requests than that the managing operators of a system (which includes the Web server computers 11-1 to 11-6) expect are concentrated on the system, the troubles (A) to (C) recited in the section “Background Art”, which may occur due to a “spike phenomenon”, can be avoided.

The above embodiment employs a structure in which the management server 150 runs on the independent management server computer 15. However, the management server 150 may be operated in any one of the Web server computers 11-1 to 11-6. In this case, it is advisable to employ a structure in which even if an abnormality occurs in the Web server computer with the management server 150 operating therein, the functions provided by the management server 150 is not interrupted. Specifically, it is sufficient if, at least, the Web server computers 11-1 to 11-6 provide such a cluster system as disclosed in the prior art document. When they provide a cluster system, even if an abnormality occurs in the Web server computer in which the management server 150 operates, the functions of the management server 150 (i.e., the functions of the server configuration management unit 151, PN management unit 152, PN start/stop unit 153, and setting change unit 154) can be taken over to another Web server computer. Further, the number of Web server computers and that of PN computers are not limited to the above-described ones. It is sufficient if at least two (i.e., a plurality of) Web server computers are employed, and at least one PN computer is employed. Furthermore, the load information acquisition unit 120 in the load distributing device 12 may acquire the load N_{S}.

### SECOND EMBODIMENT

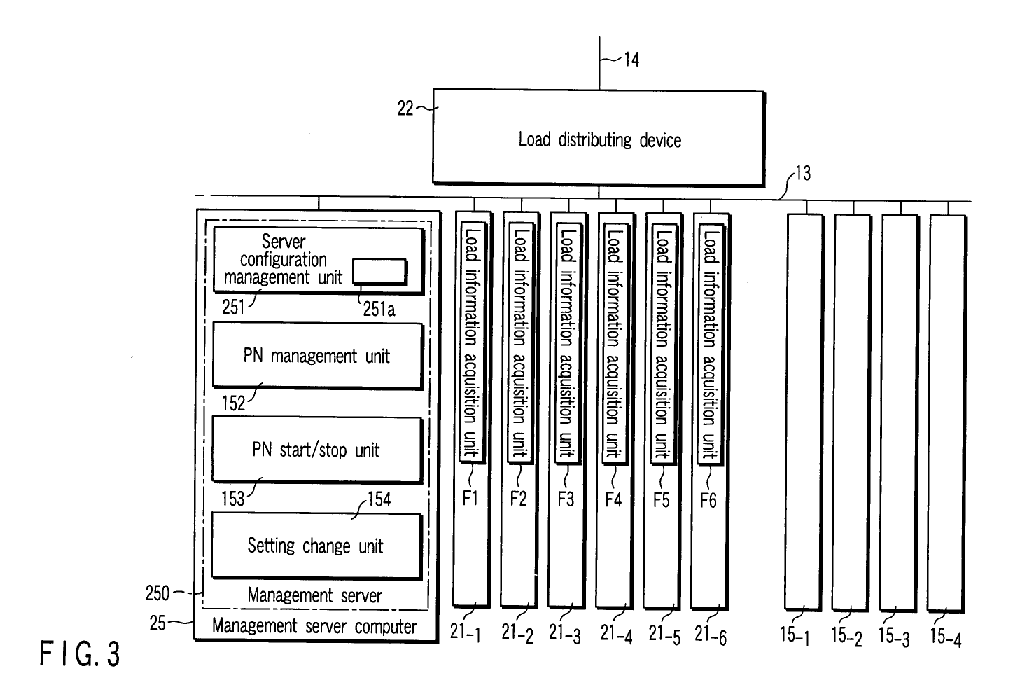

FIG. 3 is a block diagram illustrating the configuration of a load distributing system according to a second embodiment of the invention. In this figure, elements equivalent to those of FIG. 1 are denoted by corresponding reference numerals. The system of FIG. 3 differs from that of FIG. 1 in that in the former, a load distributing device 22 corresponding to the load distributing device 12 in FIG. 1 does not have a load information acquisition unit. Instead, Web server computers 21-1 to 21-6 corresponding to the Web server computers 11-1 to 11-6 in FIG. 1 include load information acquisition units F1 to F6, respectively. The load information acquisition units F1 to F6 acquire only load information concerning the Web server computers 11-1 to 11-6, respectively, which differs from the load information acquisition unit 120 in FIG. 1. Further, the computer load information items acquired by the load information acquisition units F1 to F6 do not indicate the number of sessions, but the rates of use of the CPUs included in the Web server computers 21-1 to 21-6, respectively. If a single Web server computer has a plurality of CPUs, the value acquired by adding the rates of use of these CPUs is used as the load information (computer load) of the Web sever computer. The load is not limited to the rate of use of each CPU. It is sufficient if the load reflects processing of requests in the Web server computers. The rate of use of each memory, the rate of use of each input/output unit, and the like may be used as the load, individually or in combination with the rate of use of each CPU.

Further, in the system of FIG. 3, a management server computer 25 is used in place of the management server computer 15 in FIG. 1. On the management server computer 25, a management server 250 runs. The management server 250 includes various functional elements, such as a server configuration management unit 251, PN management unit 252, PN start/stop unit 253 and setting change unit 254. Unlike the server configuration management unit 151, the server configuration management unit 251 acquires the entire load of all load distribution target computers, based on computer load information acquired by the load information acquisition unit of each load distribution target computer. The entire load is referred to as “N_{C}”. Accordingly, assume in this embodiment that the PN computers 15-1 to 15-4 as auxiliary load distribution target computers include respective load information acquisition units (not shown) similar to the load information acquisition units F1 to F6 of the Web server computers 21-1 to 21-6.

The server configuration management unit 251 holds a table 251a. The table 251a stores load threshold values for the load of all load distribution target computers employed, in relation to the numbers of PN computers (the numbers of to-be-used PN computers) to be used as load distribution targets and corresponding to the respective threshold values. FIG. 6 shows an example of the table 251a. In the example of FIG. 6, the table 251a stores three load threshold values N_{C1} N_{C2} and N_{C3} in relation to the respective numbers of to-be-used PN computers. The load threshold values N_{C1}, N_{C2} and N_{C3} correspond to the load threshold values N_{S1}, N_{S2} and N_{S3} stored in the table 151a of FIG. 5, respectively.

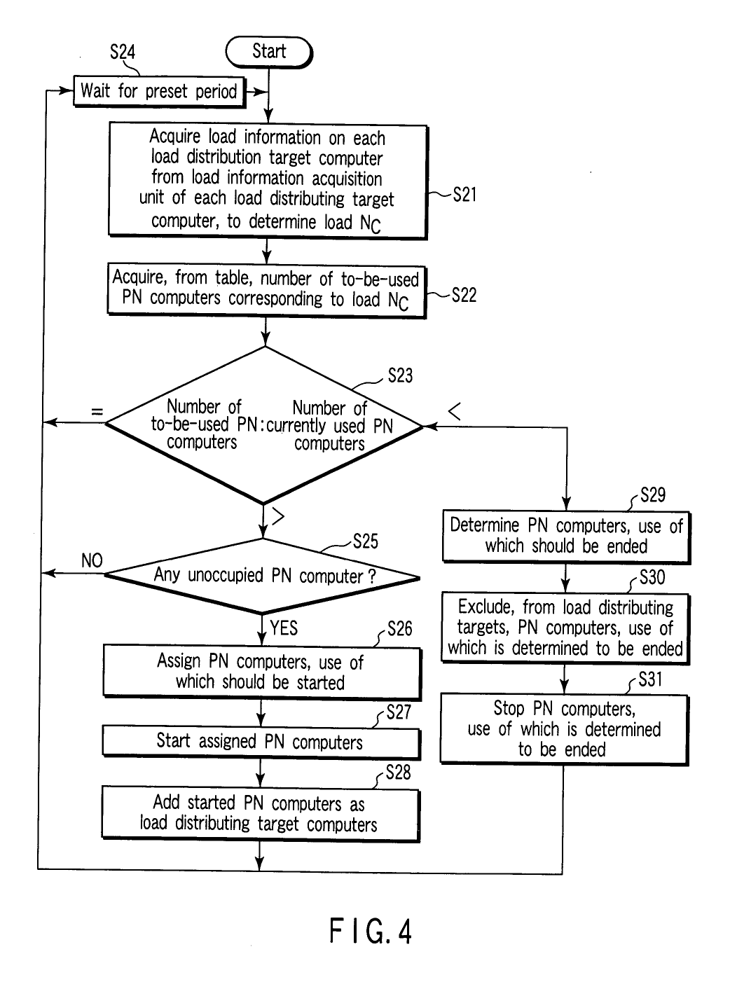

Referring to the flowchart of FIG. 4, a description will be given of the operation of the load distributing system of FIG. 3, and mainly given of the points different from those of the system shown in FIG. 1. In the load distributing system of FIG. 3, steps S21 to S31 corresponding to steps S1 to S11 in the flowchart of FIG. 2 are executed. This system mainly differs from the system of FIG. 1 in the way of acquiring a load at step S21 (which corresponds to step S1 of FIG. 2). Namely, at step S21, the server configuration management unit 251 acquires load information concerning each Web server computer 21-1, . . . , or 21-6 (load distribution target computer), which currently serves as a load distribution target, from the load information acquisition unit F1, . . . , or F6 incorporated in each Web server computer. From the acquired the load information (computer load information) concerning each load distribution target computer, the server configuration management unit 251 acquires the entire load N_{C}. In this embodiment, the addition result of the loads (the rates of use of the CPUs) of all load distribution target computers, indicated by the load information, is used as the entire load N_{C}. Alternatively, weighting using weights corresponding to (e.g., in proportion to) the processing capacities (e.g., the processing rates of the CPUs) of the load distribution target computers may be made on the loads, and the addition result of such weighted loads be used as the entire load N_{C}. The operations of the server configuration management unit 251 performed after the acquisition of the load N_{C} are similar to those of the first embodiment except that the load is changed from N_{S} to N_{C}, and the load threshold values are changed from N_{S1}, N_{S2} and N_{S3} to N_{C1}, N_{C2} and N_{C3}, respectively.

### THIRD EMBODIMENT

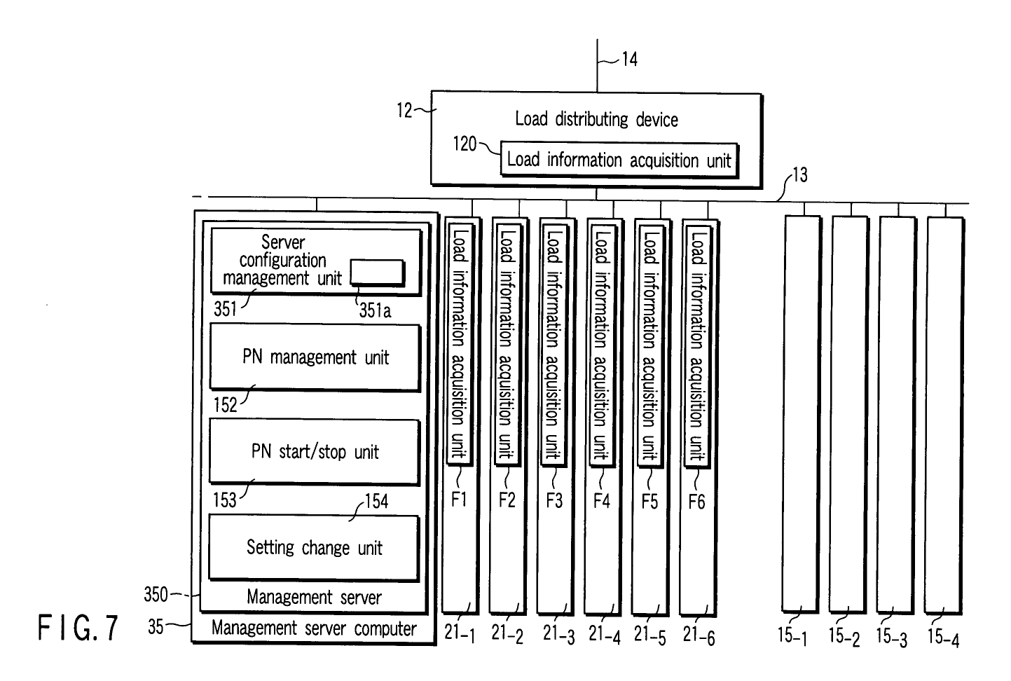

FIG. 7 is a block diagram illustrating the configuration of a load distributing system according to a third embodiment of the invention. In this figure, elements equivalent to those of FIG. 1 or FIG. 3 are denoted by corresponding reference numerals. The load distributing device 12 shown in FIG. 1 is used as the load distributing device of the system of FIG. 7, and Web server computers 21-1 to 21-6 shown in FIG. 3 are used as the Web server computers of the system of FIG. 7. The system of FIG. 7 is characterized in that it uses both the load information acquisition unit 120 of the load distributing device 12, and the load information acquisition units of all load distribution target computers, which include the load information acquisition units F1, . . . , and F6 of the Web server computers 21-1, . . . , and 21-6. Namely, to determine the number of to-be-used PN computers, the system of FIG. 7 utilizes both load information (which indicates the number of sessions) concerning each load distribution target computer, acquired from the load information acquisition unit 120, and load information (which indicates the rate of use of the CPU) acquired from the load information acquisition unit of each load distribution target computer.

Accordingly, in the system of FIG. 7, a management server computer 35 is used instead of the management server computer 15 of FIG. 1 or the management server computer 25 of FIG. 3. On the management server computer 35, a management server 350 runs. The management server 350 includes various functional elements, such as a server configuration management unit 351, PN management unit 152, PN start/stop unit 153, and setting change unit 154. The server configuration management unit 351 has functions corresponding to the functions of the server configuration management unit 151 of FIG. 1 and server configuration management unit 251 of FIG. 3. Namely, the server configuration management unit 351 acquires the load N_{S}, based on the computer load information acquired by the load information acquisition unit 120 of the load distributing device 12. The server configuration management unit 351 also acquires the load N_{C}, based on the computer load information acquired by the load information acquisition unit of each load distribution target computer.

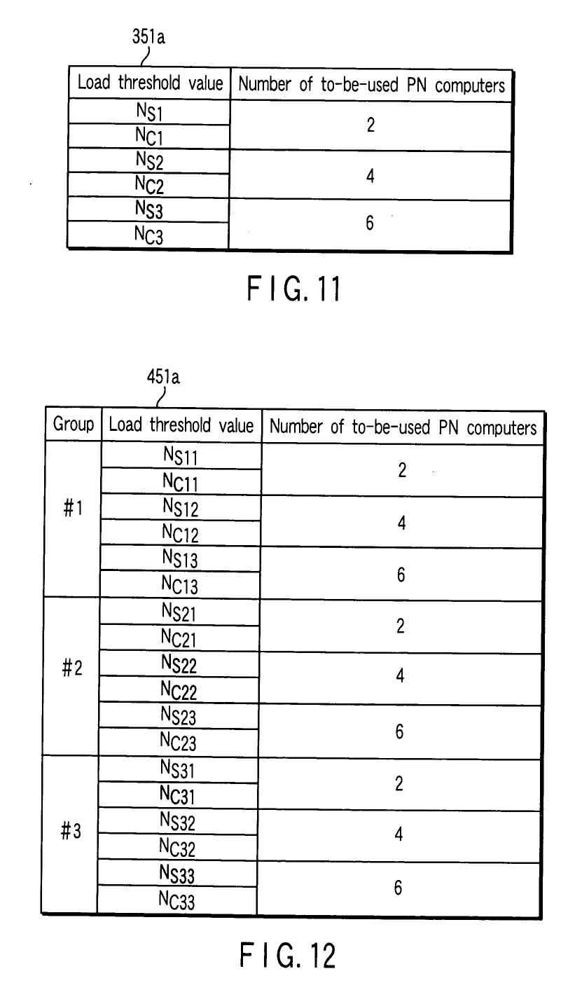

The server configuration management unit 351 holds a table 351a. FIG. 11 shows an example of the table 351a. The table 351a is characterized in that it stores the number of to-be-used PN computers in relation to both load threshold values (in this embodiment, N_{S1}, N_{S2} and N_{S3}) corresponding to the load N_{S}, and load threshold values (in this embodiment, N_{C1}, N_{C2} and N_{C3}) corresponding to the load N_{C}.

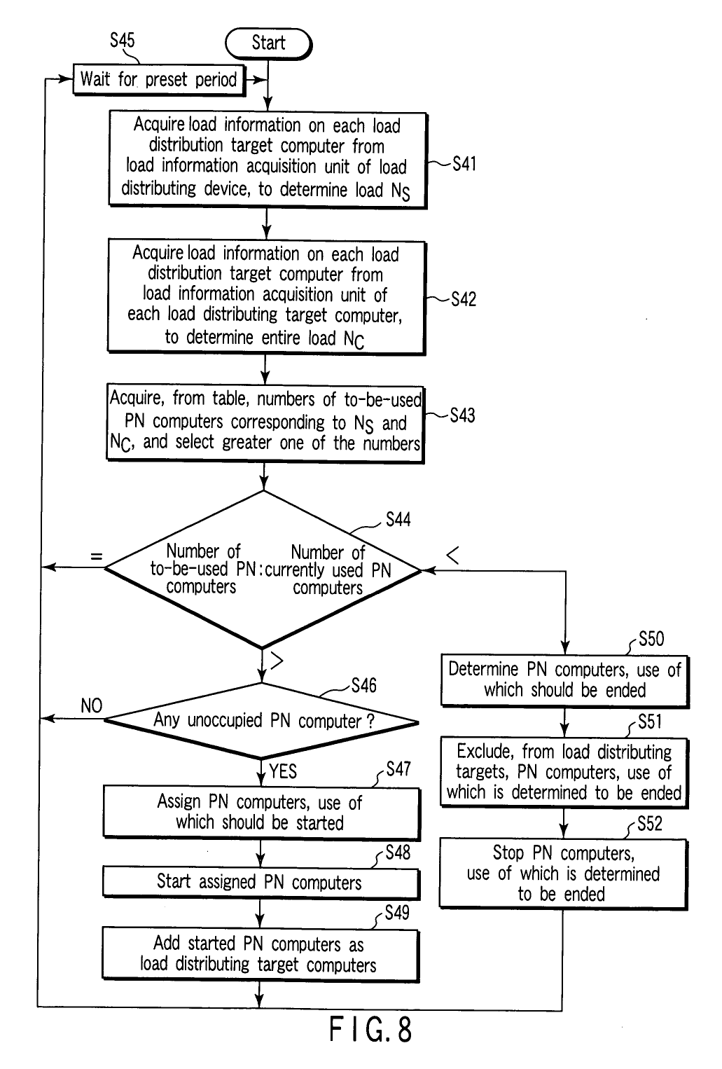

Referring to the flowchart of FIG. 8, a description will be given of the operation of the load distributing system of FIG. 7, and mainly given of the points different from those of the system shown in FIG. 1. In the load distributing system of FIG. 7, step S43 corresponding to step S2 in the flowchart of FIG. 2, and steps S44 to S52 corresponding to steps S3 to S11 in the flowchart of FIG. 2 are executed.

Specifically, in the load distributing system of FIG. 7, the server configuration management unit 351 acquires the entire load N_{S} of all load distribution target computers, based on the load information (which indicates the number of sessions) concerning each load distribution target computer, acquired by the load information acquisition unit 120 of the load distributing device 12 (step S41). The server configuration management unit 351 also acquires the entire load N_{C} of all load distribution target computers, based on the load information (which indicates the rate of use of the CPU) acquired from the load information acquisition unit of each load distribution target computer (step S42).

After acquiring the loads N_{S} and N_{C}, the server configuration management unit 351 proceeds to step S43. At step S43, the server configuration management unit 351 refers to the table 351a to determine the number of to-be-used PN computers corresponding to the present load N_{S}. Similarly, the server configuration management unit 351 also determines the number of to-be-used PN computers corresponding to the present load N_{C}, based on the contents of the table 351a. Subsequently, the server configuration management unit 351 compares the numbers of to-be-used PN computers corresponding to the loads N_{S} and N_{C}, and selects the larger one of the numbers as the number of PN computers to be actually used. The following operations are similar to those of the first embodiment.

As described above, in this embodiment, based on different types of loads N_{S} and N_{C}, the numbers n1 and n2 of PN computers necessary to suppress the spike state indicated by the loads N_{S} and N_{C} are computed individually. The larger one of the numbers n1 and n2 is selected as the number of PN computers to be actually used. As a result, the spike state can be more effectively overcome than in the first and second embodiments in which the number of PN computers to be used is determined only from one of the loads N_{S} and N_{C}.

### FOURTH EMBODIMENT

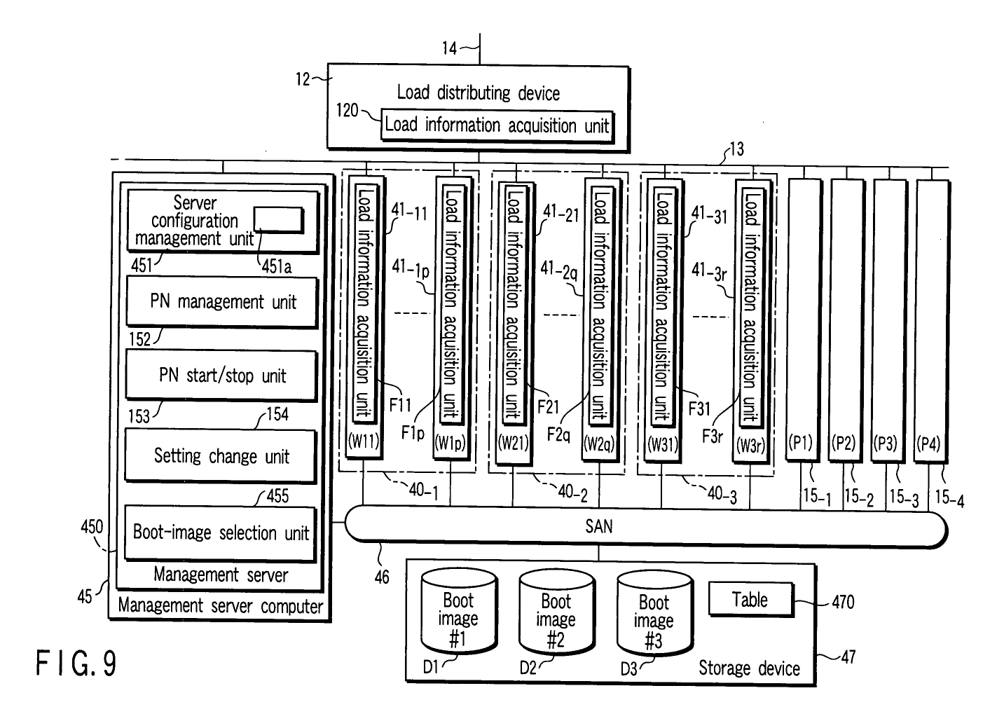

FIG. 9 is a block diagram illustrating the configuration of a load distributing system according to a fourth embodiment of the invention. In this figure, elements equivalent to those of FIG. 7 are denoted by corresponding reference numerals. Firstly, a description will be given of different points between the systems of FIGS. 7 and 9. In the system of FIG. 7, it is assumed, although not mentioned, that the Web server computers (21-1 to 21-6) execute the same type of boot image. The same can be said of the first and second embodiments. The boot image at least includes an operating system (OS). The boot image may include an application program operable under the OS. Thus, if the same boot image including the OS is executed by each Web server computer, it is possible to make a PN computer, used when a spike state occurs, correspond to the boot image for booting (starting) the computer.

In contrast, in the system of FIG. 9, different boot images are executed in different Web server computers. In this case, the Web server computers are managed, classified into groups corresponding to boot images executed therein. Further, the load used to determine the number of PN computers to be used is measured in units of groups. Depending upon in which group a load that causes a spike state occurs, the type of boot image for booting the PN computers used to suppress the state is determined. Accordingly, boot images cannot be made to correspond to the PN computers beforehand. However, if PN computers are prepared in units of groups, boot images can be made to correspond to the computers beforehand. In this case, a large number of PN computers must be prepared, which is not practical. For instance, if the PN computers are classified into three groups corresponding to three types of boot images employed, and each group includes four PN computers, 12 (=3×4) PN computers are required in total.

In light of the above, the system of FIG. 9 employs the following structure, which enables the PN computers to be booted by any boot image. The system of FIG. 9 employs three boot images #1, #2 and #3. Accordingly, the Web server computers are managed, classified into three Web server computer groups 40-1(#1) to 40-3(#3) corresponding to the boot images #1 to #3, respectively. The Web server computer group 40-1(#1) includes p Web server computers 41-11 to 41-1p booted by the boot image #1. The Web server computer group 40-2(#2) includes q Web server computers 41-21 to 41-2q booted by the boot image #2. The Web server computer group 40-3(#3) includes r Web server computers 41-31 to 41-3r booted by the boot image #3.

Further, the system of FIG. 9 employs a management server computer 45 corresponding to the management server computer 35 in FIG. 7. A management server 450 runs on the management server computer 45. The management server 450 includes various functional elements, such as a server configuration management unit 451, PN management unit 152, PN start/stop unit 153, setting change unit 154 and boot-image selection unit 455. The server configuration management unit 451 has a function for acquiring the loads N_{S} and N_{C} in units of Web server computer groups #i (i=1, 2, 3), and determining the number of to-be-used PN computers in units of groups #i, based on the loads N_{S} and N_{C}.

The server configuration management unit 451 holds such a table 451a as shown in FIG. 12. The table 451a is characterized in that it stores the number of to-be-used PN computers in units of the Web server computer groups #1 to #3 in relation to both load threshold values (in this embodiment, N_{S11}, N_{S12} and N_{S13} to N_{S31}, N_{S32} and N_{S33}) corresponding to the load N_{S}, and load threshold values (in this embodiment, N_{C11}, N_{C12} and N_{C13} to N_{C31}, N_{C32} and N_{C33}) corresponding to the load N_{C}.

When a load causing a spike state occurs in a Web server computer group 40-i(#i), and the PN management unit 152 determines one or more PN computers (hereinafter, it is assumed that a plurality of PN computers are determined), the boot-image selection unit 455 has a function for setting a boot image #i, unique to the group 40-i(#i), for the determined PN computers. The boot image #i is used in the Web server computers included in the group 40-i(#i). The setting of the boot image #i for the PN computers by the boot-image selection unit 455 means to make the PN computers correspond to a disk (disk drive) storing the boot image #i, using a table 470 described later. Namely, the boot-image selection unit 455 has a function for selecting the disk that stores the boot image #i used to boot the PN computers.

When a high load is applied to the Web server computer group 40-1(#l), a disk (disk D1 described later) storing the boot image #1 that is used in the Web server computers 41-11 to 41-1p belonging to the group is made by the boot-image selection unit 455 to correspond to the PN computers newly incorporated in the group. Similarly, when a high load is applied to the Web server computer group 40-2(#2), a disk (disk D2 described later) storing the boot image #2 that is used in the Web server computers 41-21 to 41-2q belonging to the group is made to correspond to the PN computers newly incorporated in the group. Further, when a high load is applied to the Web server computer group 40-3(#3), a disk (disk D3 described later) storing the boot image #3 that is used in the Web server computers 41-31 to 41-3r belonging to the group is made to correspond to the PN computers newly incorporated in the group.

In this embodiment, the Web sever computers 41-11 to 41-1p, Web sever computers 41-21 to 41-2q, Web sever computers 41-31 to 41-3r, management server computer 45 and PN computers 15-1 to 15-4 are connected to a storage area network (hereinafter referred to as “the SAN”) 46. The SAN 46 is also connected to a storage device 47. The storage device 47 includes disks (disk drives) D1 to D3. Namely, each of the above-described computers and the disks D1 to D3 in the storage device 47 are connected to the SAN 46. The disks D1 to D3 pre-store the boot images #1 to #3 used in the Web server computers of the Web server computer groups 40-1 to 40-3, respectively.

The storage device 47 also includes a database that holds the table 470. The table 470 stores information in which the disks D1 to D3 in the storage device 47 are related to computers that use the disks D1 to D3 as boot disks. A computer that uses a disk Di (i=1, 2, 3) as a boot disk means a boot computer that is booted (started) by the boot image #i stored in the disk Di.

FIG. 13 shows an example of the table 470. In the example of FIG. 13, the table 470 stores information (e.g., disk identifiers) in relation to information (e.g., computer identifiers). The former information indicates the disks (boot disks) D1 to D3 storing the boot images #1 to #3. The latter information indicates the computers booted by the boot images #1 to #3 stored in the disks D1 to D3, namely, the computers using the disks D1 to D3 as boot disks. In this embodiment, assume that the identifiers of the Web sever computers 41-11 to 41-1p are WS11 to WS1p, those of the Web sever computers 41-21 to 41-2q are WE21 to WS2q, and those of the Web sever computers 41-31 to 41-3r are WS31 to WS3r. Further, assume that the identifiers of the PN computers 15-1 to 15-4 are P1 to P4.

The system of FIG. 9 employs the following procedure to boot the PN computer 15-j (j is one of 1 to 4) by the boot image #i. Firstly, the boot-image selection unit 455 searches the table 470, held in the database in the storage device 47, for the identifier of the disk Di that stores the boot image #i. Subsequently, the boot-image selection unit 455 operates the table 470 to additionally set the identifier (Pj) of the PN computer 15-j in relation to the identifier (Di) of the disk Di. By the table operation of the boot-image selection unit 455, the disk Di is logically connected as the boot disk of the PN computer 15-j. This means that the disk Di storing the boot image #1 used to boot the PN computer 15-j is selected.

In this case, when the PN computer 15-j is started by the PN start/stop unit 153, it searches, via the SAN 46, the table 470 stored in the storage device 47, thereby detecting its computer identifier (Pj). From the identifier (Di) of the disk related to the computer identifier (Pj) detected in the table 470, the PN computer 15-j specifies the disk Di that stores the boot image (in this case, the boot image #1) used to boot the computer itself. The PN computer 15-j reads the boot image #1 from the specified disk Dj (i.e., the disk Dj related to the computer itself), and is booted by the boot image #1.

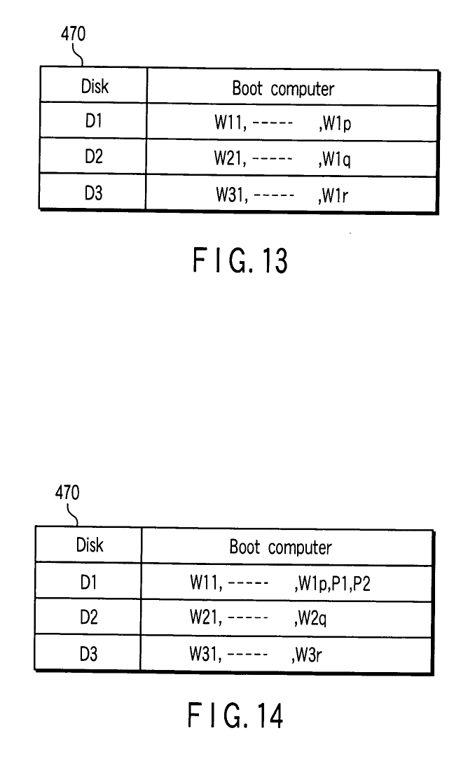

If in the table 470, the disk D1 is newly related to two PN computers 15-1 and 15-2 as shown in FIG. 14, the computers 15-1 and 15-2 use the disk D1 as a common boot disk. In this case, the PN computers 15-1 and 15-2 are booted by the boot image #1 stored in the disk D1.

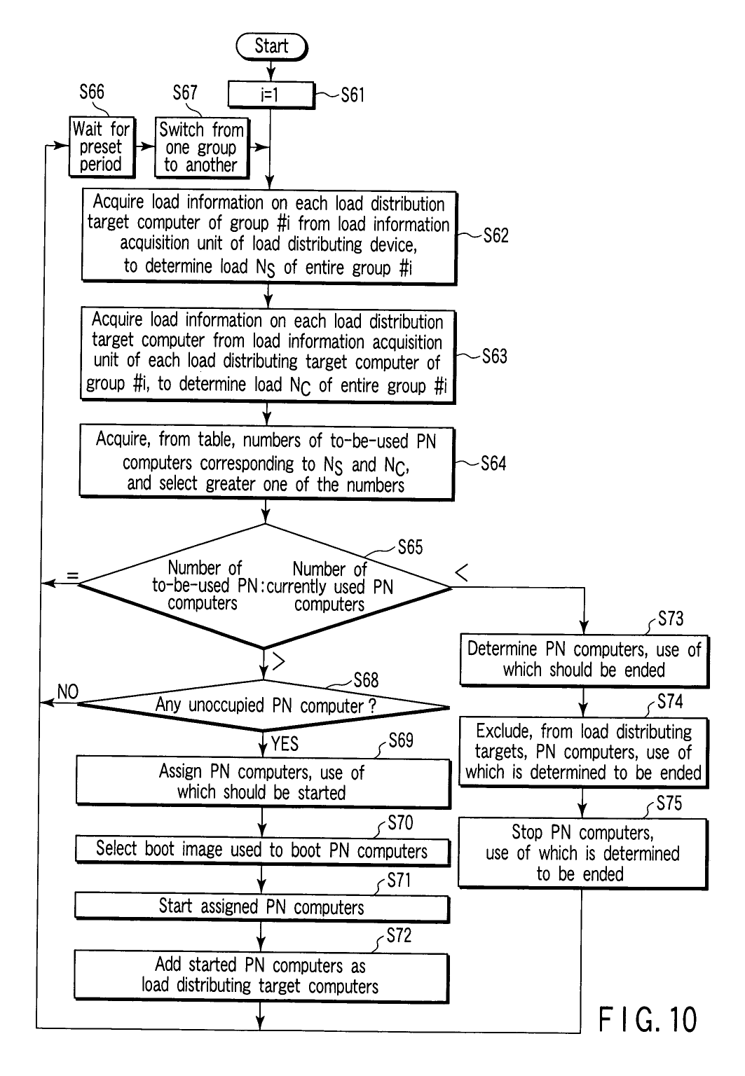

Referring now to the flowchart of FIG. 10, a description will be given of the operation of the load distributing system of FIG. 9, and mainly given of the points different from those of the system shown in FIG. 7. Firstly, the server configuration management unit 451 sets, to an initial value of 1, a variable i for designating a Web server computer group (step S61). Subsequently, the server configuration management unit 451 acquires, from the load information acquisition unit 120 of the load distributing device 12, load information (computer load information) concerning computers (load distribution target computers) that currently serve as targets of load distribution and include Web server computers belonging to the Web server group 40-i(#1), thereby acquiring the entire load N_{S} of the group 40-i(#i) (step S62). Further, the server configuration management unit 451 acquires load information concerning load distribution target computers from the load information acquisition units of the load distribution target computers that include the load information acquisition units of Web server computers belonging to the Web server group 40-i(#1), thereby acquiring the entire load N_{C} of the group 40-i(#i) (step S63). Steps S62 and S63 differ from steps S41 and S42 of FIG. 8 in that in the former steps, the loads N_{S} and N_{C} of the entire group #i designated by variable i are acquired, whereas in the latter steps, the loads N_{S} and N_{C} of the entire system are acquired.

After acquiring the entire loads N_{S} and N_{C} of the group 40-i(#i), the server configuration management unit 451 proceeds to step S64. At step S64, the server configuration management unit 451 refers to the entries of the group 40-i(#i) in the table 451a to determine the number n1 of to-be-used PN computers corresponding to the present load N_{S} of the group 40-i(#i). Similarly, the server configuration management unit 451 determines the number n2 of to-be-used PN computers corresponding to the present load N_{C} of the group 40-i(#i), based on the entries of the group 40-i(#i) in the table 451a. Subsequently, the server configuration management unit 451 compares the numbers n1 and n2 of to-be-used PN computers corresponding to the loads N_{S} and N_{C} of the group 40-i(#i), and selects the larger one of the numbers as the number of to-be-used PN computers to be actually used.

The operations performed after step S64 are substantially similar to those performed after step S43 in FIG. 8. However, this embodiment differs in the following operations. Assume here that a load causing a spike state occurs in the Web server computer group 40-i(#i). In this case, to reduce the load, the PN management unit 152 assigns, to the group 40-i(#i), at least one PN computer that should be started to be used (step S69). At this time, in the fourth embodiment, the PN management unit 152 transfers control to the boot-image selection unit 455. The boot-image selection unit 455, in turn, makes the PN computer, assigned to the group 40-i(#i), correspond to the disk Di that stores the boot image #i unique to the group 40-i(#i). In other words, the boot-image selection unit 455 selects the boot image #i (the disk Di storing the boot image #i) used to boot the PN computer assigned to the group 40-i(#i) (step S70).

After the boot-image selection unit 455 selects the boot image #i used to boot the PN computer that should be started to be used, the PN start/stop unit 153 operates. The PN start/stop unit 153 starts the one of the PN computers 15-1 to 15-4 that is assigned by the PN management unit 152 (step S71). By the table operation of the boot-image selection unit 455, the started PN computer is made to correspond to the disk Di storing the boot image #i used to boot the computer. Namely, the boot image #i used to boot the started PN computer is selected by the boot-image selection unit 455. The started PN computer reads the selected boot image #i from the disk Di to execute boot processing.

When the PN computer is started by the PN start/stop unit 153, the setting change unit 154 controls the load distributing device 12 so that the started PN computer will belong to the Web server computer group 40-i(#i), and will become a load distribution target computer, along with the other computers in the group 40-i(#i) (step S72). The order of steps S71 and S72 may be reversed.

When target change of load distributing by the load distributing device 12 is made by the control of the setting change unit 154, the server configuration management unit 451 is kept in a standby state for a preset time (step S66). Then, the unit 451 switches the target of processing from one Web server computer group to another (step S67). In the embodiment that employs three Web server computer groups #1 to #3, if the group #1 is the present group, it is switched to the group #2. If the group #2 is the present group, it is switched to the group #3. If the group #3 is the present group, it is switched to the group #1. Step S62 and the later steps are again executed on the Web server computer group acquired by switching.

As described above, in the fourth embodiment, the Web server computers in the system are classified into the Web server computer groups 40-1(#1) to 40-3(#3), depending upon the types of boot images executed by the Web server computers in the system. When a load causing a spike state occurs in any group 40-i(#i) included in the groups 40-1(#1) to 40-3(#3), a PN computer is selected from the PN computers 15-1 to 15-4 and made to correspond to the boot image #i (the disk Di storing the boot image #i) unique to the group 40-i(#i). As a result, the selected PN computer can be started as a load distribution target computer belonging to the group 40-i(#i). Thus, the PN computers 15-1 to 15-4 can be effectively utilized.

### MODIFICATION OF THE FOURTH EMBODIMENT

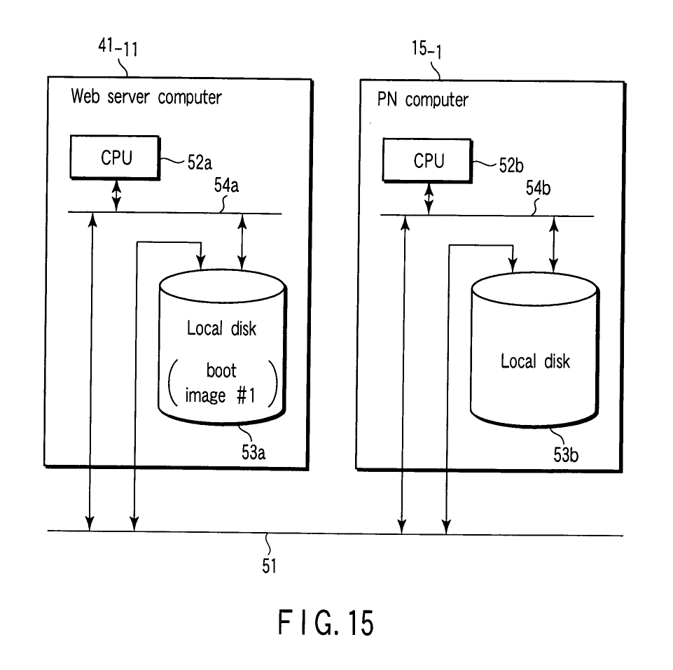

In the system of FIG. 9, the PN computer 15-j is booted by the boot image #i stored in the disk Di in the storage device 47. However, the disk Di is not always necessary to boot the PN computer 15-j using the boot image #i. Referring now to the block diagram of FIG. 15, a description will be given of a modification of the fourth embodiment, in which the PN computer 15-j can be booted by the boot image #i without using the disk Di in the storage device 47. In FIG. 15, elements equivalent to those of FIG. 9 are denoted by corresponding reference numerals.

In FIG. 15, the Web server computer 41-11 and PN computer 15-1 are connected to an input/output bus (external input/output bus) 51. The Web server computer 41-11 belongs to the Web server computer group 40-1 (see FIG. 9). Although not shown in FIG. 15, the input/output bus 51 is also connected to the server computers other than the Web server computer 41-11, which belong to the Web server computer group 40-1, the server computers belonging to the other Web server computer groups 40-2 and 40-3, and the PN computers other than the PN computer 15-1.

The computers 41-11 and 15-1 include CPUs 52a and 52b, local disks (local disk drives) 53a and 53b, and input/output buses (internal input/output buses) 54a and 54b, respectively. The local disk 53a of the computer 41-11 stores the boot image #1 unique to the Web server computer group 40-1(#1) and used to boot the computer 41-11. The CPU 52a and local disk 53a are connected to each other by the input/output bus 54a, and the CPU 52b and local disk 53b are connected to each other by the input/output bus 54b. Further, the local disks 53a and 53b are connected to the input/output bus 51, and the input/output buses 54a and 54b are also connected to the input/output bus 51.

Assume here that the PN computer 15-1 in FIG. 15 is assigned to the Web server computer group 40-1 in FIG. 9. In this case, the boot-image selection unit 455 shown in FIG. 9 requires one of the Web server computers 41-11 to 41-1p belonging to the group 40-1, e.g. the Web server computer 41-11, to copy the boot image to the PN computer 15-1. This means that the boot image #1 stored in the local disk 53a of the Web server computer 41-11 belonging to the group 40-1 is selected as the boot image to boot the PN computer 15-1. At this time, the PN computer 15-1 is not yet started.

In response to the request to copy issued from the boot-image selection unit 455, the CPU 52a of the Web server computer 41-11 reads the boot image #1 from the local disk 53a of the computer 41-11, and copies it to the local disk 53b of the PN computer 15-1 via the input/output bus 51. By the copying operation of the CPU 52a of the Web server computer 41-11, the boot image #1 can be copied to the local disk 53b of the PN computer 15-1, even if the PN computer 15-1 is not started. Many cluster computers and blade server computers have such a function as this.

After the boot image #1 is copied, the PN start/stop unit 153 shown in FIG. 9 starts the PN computer 15-1. The PN computer 15-1, in turn, boots itself, using the boot image #1 copied in the local disk 53b thereof. More specifically, the CPU 52b of the PN computer 15-1 reads the boot image #1 from the local disk 53b via the input/output bus 54b, and boots it. Note that in FIG. 15, the input/output buses 54a and 54b are provided inside the computers 41-11 and 15-1, respectively, and the input/output bus 51 is provided outside the computers 41-11 and 15-1. However, this bus configuration is just an example. In short, it is sufficient if the computer 41-11 having the local disk 53a with a boot image stored therein can directly or indirectly copy the boot image (data) to the local disk 53b of the computer 15-1 that is not started.

### FIFTH EMBODIMENT

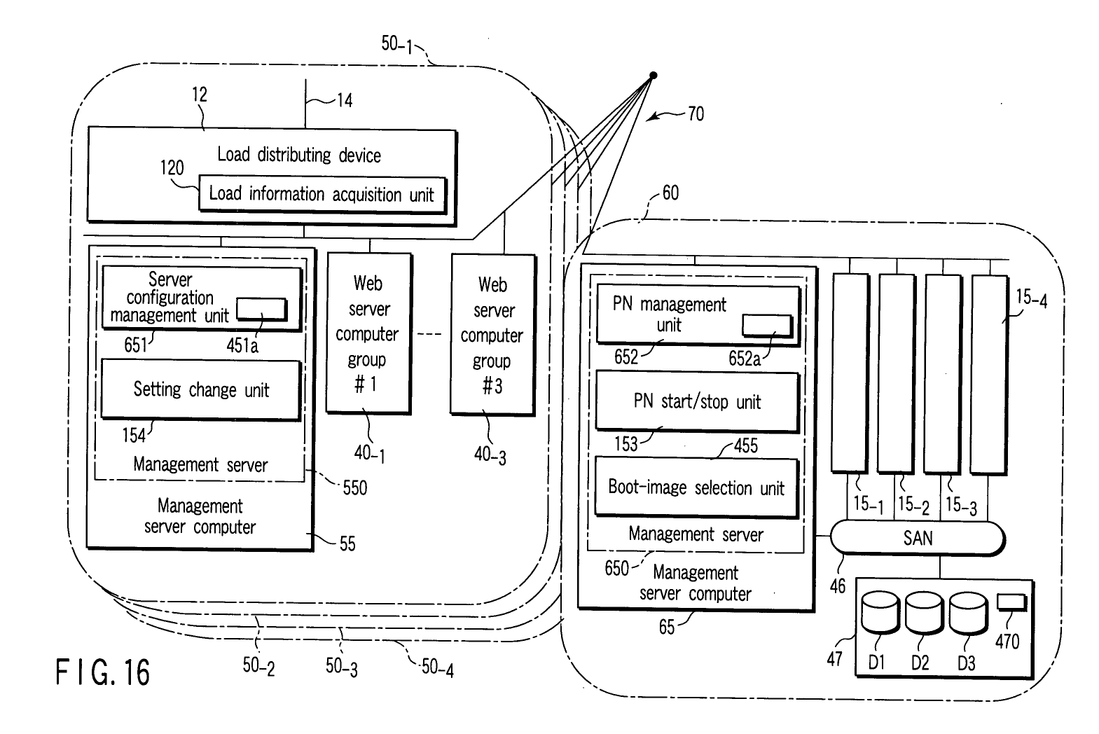

FIG. 16 is a block diagram illustrating the configuration of a load distributing system according to a fifth embodiment of the invention. In FIG. 16, elements equivalent to those of FIG. 9 are denoted by corresponding reference numerals. The system of FIG. 16 is characterized by comprising Web server sites 50-1 to 50-4 managed by a plurality (e.g., four) of different management bodies (for example, different companies), and a common provisioning node computer site (hereinafter referred to as “the common PN computer site”) 60 as an auxiliary site that can be utilized by the Web server sites 50-1 to 50-4.

The Web server site 50-1 comprises elements that are similar to those of the system of FIG. 9, but do not include the PN computers 15-1 to 15-4, SAN 46 or storage devices 47-1 to 47-3. Namely, the Web server site 50-1 comprises the load distributing device 12, a plurality of, e.g., three, Web server computer groups 40-1 to 40-3, and a management server computer 55 corresponding to the management server computer 45 in FIG. 9. In the management server computer 55, a management server 550 operates. The management server 550 includes a server configuration management unit 551 and the setting change unit 154. The other Web server sites 50-2 to 50-4 have the same structure as the Web server site 50-1, although not shown. Note that the number of Web server computer groups, the number of Web server computers in each group, or the like, is not necessarily equal between the Web server sites 50-1 to 50-4. In the embodiment, however, to facilitate the explanation, it is assumed that each of the Web server computer groups in the Web server sites 50-1 to 50-4 correspond to any one of the boot images #1 to #3.

The server configuration management unit 551 in the management server 550 has a function for acquiring the entire loads N_{S} and N_{C} of the group 40-i(#i), like the server configuration management unit 451 of FIG. 9. The server configuration management unit 551 also has a function for determining the number of PN computers, the use of which should be started or stopped, based on the table 451a of a data structure shown in FIG. 12, and the loads N_{S} and N_{C}, like the server configuration management unit 451 of FIG. 9. The server configuration management unit 551 further has a function for requesting a management server 650, described later, incorporated in the common PN computer site 60 to start or stop the use of the determined PN computers.

On the other hand, the common PN computer site 60 comprises the PN computers 15-1 to 15-4 and storage device 47. As in the system of FIG. 9, the storage device 47 comprises the disks D1 to D3 storing the boot images #1 to #3, and the database holding the table 470. The PN computers 15-1 to 15-4 are connected to the storage device 47 by the SAN 46. By virtue of this structure, each of the PN computers 15-1 to 15-4 can be booted by the corresponding one of the boot images #1 to #3.

The PN computers 15-1 to 15-4 are connected via a network 70 to the load distributing device 12, management server computer 55 and Web server computer groups 40-1 to 40-3 (the Web server computers belonging to the groups 40-1 to 40-3), which are incorporated in the Web server site 50-1. The PN computers 15-1 to 15-4 are also connected via the network 70 to the load distributing device, management server computer and Web server computer groups (which are not shown) of each of the other Web server sites 50-2 to 50-4. As a result, an arbitrary one of the PN computers can also be assigned as a load distribution target computer that belongs to an arbitrary one of the Web server computer groups of an arbitrary one of the Web server sites.

In light of the above, the common PN computer site 60 includes a management server computer 65 for processing a request to start the use of a provisioning node, and a request to stop the use of a provisioning node, issued from each of the Web server sites 50-1 to 50-4 as management bodies. The management server computer 65 is also connected to the network 70 and SAN 46. On the management server computer 65, a management server 650 runs which has a function for processing the request to start the use of a provisioning node, and the request to stop the use of a provisioning node. The management server 650 includes various functional elements, such as a PN management unit (provisional node management unit) 652, PN start/stop unit 153 and boot-image selection unit 455.

The PN management unit 652 has a function for managing the states of use of the PN computers 15-1 to 15-4. The PN management unit 652 also has a function for receiving a request to start the use of a provisioning node or to stop the use of a provisioning node, issued from each of the Web server sites 50-1 to 50-4, and controlling the PN start/stop unit 153 and boot-image selection unit 455 to process the request.

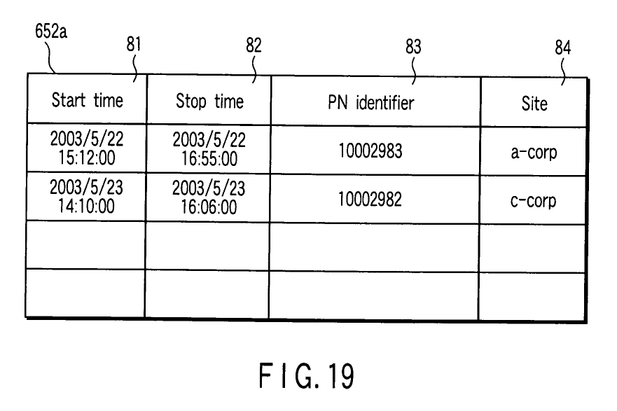

The PN management unit 652 holds the record file 652a of a data structure shown in FIG. 19. The record file 652a stores records concerning the use of the PN computers. Each record contains information indicating the state of use of a PN computer started in response to a request from each of the Web server sites 50-1 to 50-4. Specifically, each record concerning the use of a PN computer includes fields 81 to 84. The field 81 is used to record the time (i.e., start time) when a PN computer is started. The field 82 is used to record the time (i.e., stop time) when the PN computer is stopped. From the start time and stop time recorded in the fields 81 and 82, the period (operation period) in which the PN computer operates is detected. The field 83 is used to record information, e.g., a provisioning node identifier, for identifying a PN computer. The field 84 is used to record information concerning a Web server site using the provisioning node indicated by the identifier recorded in the field 83. Each record stored in the record file 652a can utilize various formats, other than that shown in FIG. 19, such as a log format. Further, the information items indicating the start time and stop time may be stored as other records. Information indicating the period (stop period) in which the PN computer is stopped may be recorded as a record instead of the period in which it operates.

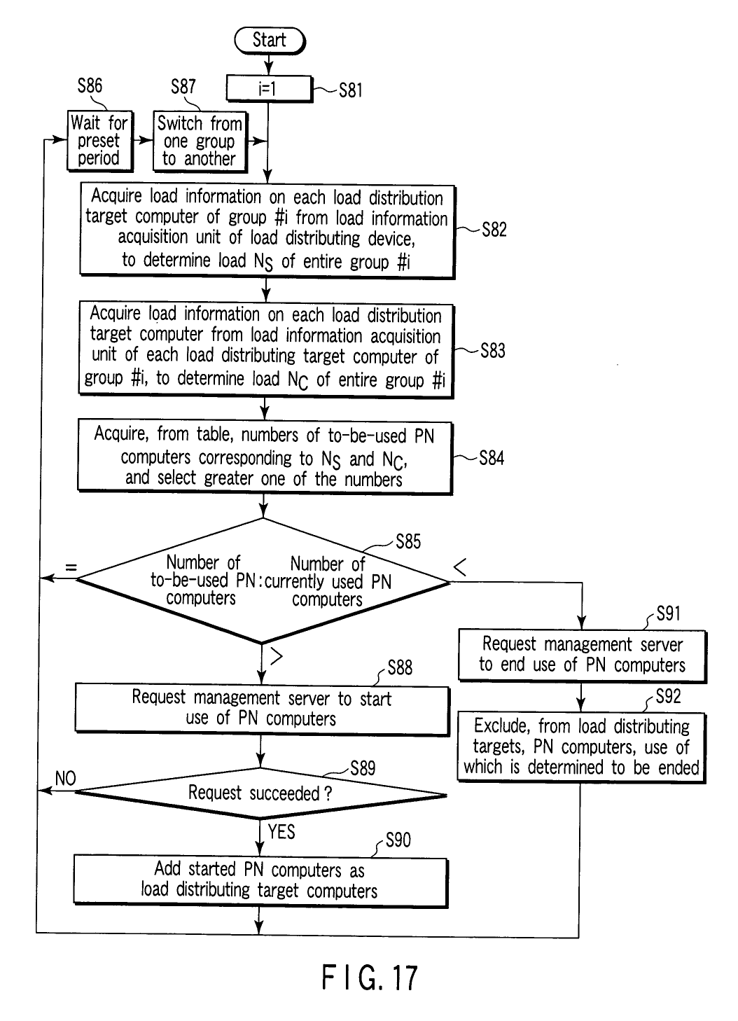

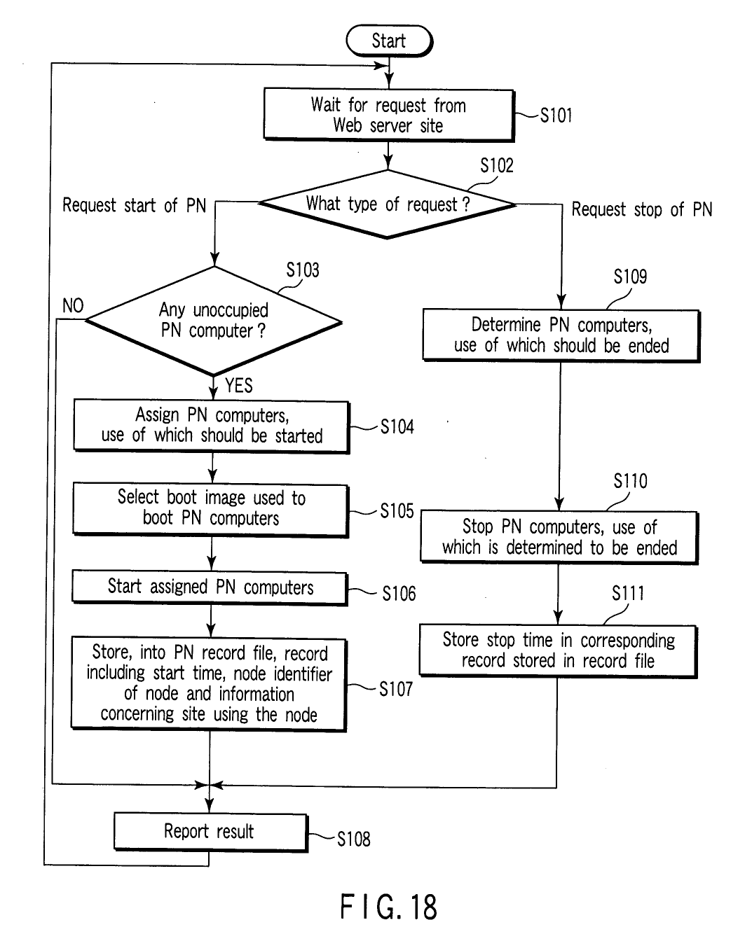

Referring to the flowcharts of FIGS. 17 and 18, a description will be given of the operation of the load distributing system of FIG. 16, and mainly given of the points different from those of the system shown in FIG. 9. The server configuration management unit 551 that operates in the management server computer 55 of the Web server site 50-1 firstly executes the same processes (steps S81 to S85) as those of steps S61 to S65 in FIG. 10. Specifically, the server configuration management unit 551 sets a variable i to an initial value of 1 (step S81), and then acquires the entire loads N_{S} and N_{C} of the Web server computer group 40-i(#i) indicated by the variable i (steps S82 and S83). Subsequently, the server configuration management unit 551 refers to the table 451a to determine the numbers n1 and n2 of to-be-used PN computers corresponding to the present loads N_{S} and N_{C} of the group 40-i(#i) (step S83). At step S83, the server configuration management unit 551 selects the larger one of the numbers n1 and n2 corresponding to the loads N_{S} and N_{C} as the number of PN computers to be actually used. After that, the server configuration management unit 551 compares the selected number with the number of currently used PN computers (step S85). The number of currently used PN computers is managed by the PN management unit 652 of the common PN computer site 60.

If the numbers are equal to each other, the server configuration management unit 551 is kept in a standby state for a preset period (step S86), and then operates the variable i to switch from one Web server computer group to another (step S87). As a result, step S82 and the later steps are again performed on the Web server computer group acquired by switching.

In contrast, if the number of to-be-used PN computers is larger (step S85), the server configuration management unit 551 determines that it is necessary to assign new PN computers as load distribution target computers. In this case, the server configuration management unit 551 requests, via the network 70, the management server 650 of the management server computer 65 to start the use of new PN computers corresponding to the difference Nd between the compared numbers (step S88).

Further, if the number of to-be-used PN computers is smaller than the number of currently used PN computers (step S85), the server configuration management unit 551 determines that it is necessary to stop the use of the currently used PN computers corresponding to the difference Nd. In this case, the server configuration management unit 551 requests, via the network 70, the management server 650 of the management server computer 65 for PN computer management to stop the use of the currently used PN computers corresponding to the difference Nd (step S91).

The PN management unit 652 of the management server 650 waits for a request (a request to start or stop the use of a PN computer) from each of the Web server sites 50-1 to 50-4 (step S101). Assume here that the PN management unit 652 has received a request from, for example, the management server 550 of the management server computer 55 in the Web server site 50-1. In this case, the PN management unit 652 determines whether the received request is a request to start or stop the use of a PN computer (step S102).

If the received request is a request to start the use of a PN computer, the PN management unit 652 determines whether the PN computers 15-1 to 15-4 contain an unoccupied PN computer (step S103). If there is an unoccupied PN computer, the PN management unit 652 assigns the PN computer as a computer that should be started to be used (step S104).

The boot-image selection unit 455 in the management server 650 makes the PN computer, assigned by the PN management unit 652, correspond to the disk Di that stores the boot image #i. In other words, the boot-image selection unit 455 selects the boot image #i (the disk Di storing the boot image #i) used to boot the PN computer assigned by the PN management unit 652 (step S105). At this time, the PN start/stop unit 153 in the management server 650 operates. The PN start/stop unit 153 starts the one of the PN computers 15-1 to 15-4 that is assigned by the PN management unit 652 (step S106). The started PN computer is made by the boot-image selection unit 455 to correspond to the disk Di that stores the boot image #i used to boot the PN computer. Accordingly, the started PN computer reads the boot image #i from the disk Di made to correspond thereto, and executes boot processing.

When the PN computer assigned as a computer that should be started to be used is started, the PN management unit 652 stores, in the record file 652a, a record that stores the start time, the identifier (provisioning node identifier) of the started PN computer, and information indicating the Web server site (in this case, the Web server site 50-1) that uses the PN computer (step S107). The domain name of the Web server site is used as the information indicating the site. The domain name is made to correspond to an IP (Internet Protocol) address by a DNS (Domain Name System) not shown.

After executing step S107, the PN management unit 652 informs the management server 550, via the network 70, of the result of processing made in reply to the request therefrom (the request to start the use of the PN computer) (step S108).

In contrast, if any unoccupied PN computer does not exist (step S103), the PN management unit 652 reports this to the requester of the start of use of the PN computer (i.e., the management server 550 of the Web server site 50-1) (step S108).

Further, if the request from the management server 550 of the Web server site 50-1 is a request to stop the use of a PN computer (step S102), the PN management unit 652 selects, from the currently used PN computers, the PN computer, the use of which should be ended (step S109). The PN start/stop unit 153 stops the PN computer, the use of which is determined by the PN management unit 652 to be ended (step S110). At this time, the PN management unit 652 searches the record file 652a for the record that stores the identifier of the stopped PN computer and has its stop-time field 82 kept blank, and writes the present time to the field 82 as the stop time (step S111). After that, the PN management unit 652 informs the management server 550 of the Web server site 50-1, via the network 70, of the result of processing made in reply to the request therefrom (the request to stop the use of the PN computer) (step S108).

When the server configuration management unit 551 in the management server 550 of the Web server site 50-1 has issued a request to start the use of a PN computer to the management server 650 of the common PN computer site 60 (step S88), it waits for the result of processing issued from the PN management unit 652 in the management server 650. Upon receiving the result of processing made in reply to the request to start the use of a PN computer, the server configuration management unit 551 determines from the result whether the request has succeeded (step S89). If succeeded, the PN management unit 652 transfers control to the setting change unit 154. The setting change unit 154, in turn, controls the load distributing device 12 so that the PN computer started in reply to the request to start the use of a PN computer will be added in the Web server computer group 40-i(#i) as a load distribution target computer (step S90).

As described above, in this embodiment, the Web server sites 50-1 to 50-4 as four different management bodies can utilize the PN computers of the common PN computer site (auxiliary site) 60. Further, the record file 652a can be used as information indicating, for example, the fees for the PN computers that the management bodies have used.

In this embodiment, it is assumed that a plurality of Web server computers belonging to each of the Web server sites 50-1 to 50-4 are managed, classified into groups corresponding to the respective types of boot images. However, in each of the Web server sites 50-1 to 50-4, all Web server computers may execute the same type of boot image. In this case, it is not necessary to classify the Web server computers in each of the Web server sites 50-1 to 50-4 into groups. Further, when the Web server computers in each of the Web server sites 50-1 to 50-4 execute the same type of boot image, the storage device 47 and boot image selection unit 455 incorporated in the common PN computer site 60 are also unnecessary. Also, instead of the dedicated load distributing device 12, the round-robin function of the DNS (Domain Name System) may be used as a load distributing device. This can be said of the load distributing devices employed in the first to fourth embodiments. The DNS round-robin function is a function for distributing the load of a well-trafficked server utilizing a DNS in which domain names are associated with IP addresses. More specifically, this is a function for assigning a plurality of IP addresses to a single domain name, and sequentially responding to requests sequentially issued, thereby preventing concentration of access to a single computer.

The present invention is not limited to the above-described embodiments, but may be modified in various ways without departing from the scope. Various inventions can be realized by appropriately combining the structure elements disclosed in the embodiments. For instance, some of the disclosed structural elements may be deleted. Some structural elements of different embodiments may be combined appropriately.

### INDUSTRIAL APPLICABILITY

In the present invention, when a sudden spike phenomenon occurs, an auxiliary computer is started and used as a new load distribution target computer. When the spike phenomenon has ceased, the booted auxiliary computer is excluded from the load distribution targets, and stopped. Thus, it is not necessary to boot many server computers at all times, and a sudden spike phenomenon that is hard to predict can be easily overcome.

1. A load distributing system comprising:
a plurality of server computers which process requests from a plurality of client computers, the server computers being managed, classified into a plurality of server computer groups corresponding to different types of boot images, the different types of boot images including operating systems executed by the server computers;
a load distributing device configured to distribute the requests from the client computers between a plurality of load distribution target computers including the server computers;
a plurality of provisioning computers usable as load distribution target computers, the provisioning computers being started when the provisioning computers are used as the load distribution target computers;
a server configuration management unit configured to determine, for each server computer group, number of provisioning computers, use of which as new load distribution target computers is to be started, or use of which as load distribution target computers is to be ended, based on a load of all load distribution target computers including the server computers of said each server computer group;
a provisioning-computer management unit configured to manage states of use of the provisioning computers, the provisioning computer management unit determining provisioning computers corresponding to the number of provisioning computers determined by the server configuration management unit for said each server computer group, use of the corresponding provisioning computers as the new load distribution target computers being to be started, or use of the corresponding provisioning computers as the load distribution target computers being to be ended;
a provisioning-computer start/stop unit configured to start or stop the provisioning computers determined by the provisioning-computer management unit;
a setting change unit configured to add, as load distribution target computers that are targets of load distribution by the load distributing device, the provisioning computers determined by the provisioning-computer management unit, or configured to exclude, from load distribution target computers that are targets of load distribution by the load distributing device, the provisioning computers determined by the provisioning-computer management unit; and
a boot-image selection unit configured to select, from the different types of boot images, a boot image corresponding to said each server computer group which includes the provisioning computers determined by the provisioning-computer management unit and started to be used as the load distribution target computers, the boot image being used to boot the provisioning computers determined by the provisioning-computer management unit,
wherein when the provisioning computers determined by the provisioning-computer management unit are started by the provisioning-computer start/stop unit, the provisioning computers are booted by the boot image selected by the boot-image selection unit.

2. The load distributing system according to claim 1, further comprising:
a plurality of boot-image storing units which store the respective different types of boot images; and
a corresponding information storing unit which stores information for relating each of the boot-image storing units to ones of computers booted by the boot image stored in said each boot-image storing unit,
and wherein:
the boot-image selection unit selects the boot image used to boot the provisioning computers, determined by the provisioning-computer management unit, by relating, using the corresponding information storing unit, the provisioning computers, determined by the provisioning-computer management unit, to a boot-image storing unit storing the boot image corresponding to said each server computer group which includes the provisioning computers determined by the provisioning-computer management unit and started to be used as the load distribution target computers; and
when the provisioning computers determined by the provisioning-computer management unit are started by the provisioning-computer start/stop unit, the provisioning computers boot themselves using the boot image selected by the boot-image selection unit and read from the boot-image storing unit which is related by the corresponding information storing unit to the provisioning computers determined by the provisioning-computer management unit.

3. The load distributing system according to claim 1, wherein:
the server computers and the provisioning computers include boot-image storing units which store boot images used to boot the server computers and the provisioning computers;
the boot-image selection unit requests an arbitrary server computer included in said each server computer group to copy a boot image from the boot-image storing unit of the arbitrary server computer to the provisioning computers determined by the provisioning-computer management unit, said each computer group including the provisioning computers determined by the provisioning-computer management unit and started to be used as the load distribution target computers; and
each of the server computers copies the boot image, selected by the boot-image selection unit and stored in the boot-image storing unit of said each server computer, to the boot-image storing units of the provisioning computers determined by the provisioning-computer management unit, when the boot-image selection unit requests copying.

4. The load distributing system according to claim 1, further comprising:
a plurality of server sites each including the server computers managed, classified into the server computer groups, the load distributing device, the server configuration management unit and the setting change unit;
a provisioning site including the provisioning computers, the provisioning-computer management unit, the provisioning-computer start/stop unit, the boot-image selection unit and the boot-image storing units; and
a network connecting the server sites to the provisioning site, and
wherein the server configuration management unit of each of the server sites requests, via the network, the provisioning site to start or end the use of the provisioning computers of said each server computer group, when the number of provisioning computers is determined for said each server computer group, the use of the provisioning computers as the new load distribution target computers being to be started, or the use of the provisioning computers as the load distribution target computers being to be ended,; and
the provisioning-computer management unit of the provisioning site determines, in accordance with a request to start or end the use of the provisioning computers of said each server computer group, issued from the server configuration management unit of said each server site, the provisioning computers corresponding to the number of provisioning computers determined by the server configuration management unit of said each server site, the use of the corresponding provisioning computers being to be started as the new load distribution target computers, or the use of the corresponding provisioning computers as the load distribution target computers being to be ended.

5. The load distributing system according to claim 4, wherein when the provisioning computers corresponding to the number of provisioning computers determined by the server configuration management unit of said each sever site are started or stopped, the provisioning-computer management unit of the provisioning site stores information indicating a start time or a stop time of the provisioning computers corresponding to the number of provisioning computers determined by the server configuration management unit of said each sever site, information indicating the provisioning computers corresponding to the number of provisioning computers determined by the server configuration management unit of said each sever site, and information indicating said each server site.

6. A load distributing system comprising:
a plurality of server computers which process requests from a plurality of client computers;
a load distributing device configured to distribute the requests from the client computers between a plurality of load distribution target computers including the server computers;
a plurality of provisioning computers usable as load distribution target computers, the provisioning computers being started when the provisioning computers are used as the load distribution target computers;
a server configuration management unit configured to determine, based on a load of all load distribution target computers including the server computers, number of provisioning computers, use of which as new load distribution target computers is to be started, or use of which as load distribution target computers is to be ended;
a provisioning-computer management unit configured to manage states of use of the provisioning computers, the provisioning computer management unit determining provisioning computers corresponding to the number of provisioning computers determined by the server configuration management unit, use of the corresponding provisioning computers as the new load distribution target computers being to be started, or use of the corresponding provisioning computers as the load distribution target computers being to be ended;
a provisioning-computer start/stop unit configured to start or stop the provisioning computers determined by the provisioning-computer management unit; and
a setting change unit configured to add, as load distribution target computers that are targets of load distribution by the load distributing device, the provisioning computers determined by the provisioning-computer management unit, or configured to exclude, from load distribution target computers that are targets of load distribution by the load distributing device, the provisioning computers determined by the provisioning-computer management unit.

7. The load distributing system according to claim 6, wherein the server configuration management unit, the provisioning-computer management unit, the provisioning-computer start/stop unit, and the setting change unit operate in a management server computer independent of the server computers and the provisioning computers.

8. The load distributing system according to claim 6, wherein:
the server computers form a cluster system in which when any one of the server computers is malfunctioned, a service provided by said any sever computer is taken over to any other of the server computers; and
the server configuration management unit, the provisioning-computer management unit, the provisioning-computer start/stop unit, and the setting change unit operate in any one of the server computers included in the cluster system, and are treated as targets to be taken over to any other of the server computers when said any server computer is malfunctioned.

9. The load distributing system according to claim 6, wherein:
the load distributing device includes a load information acquisition unit configured to acquire computer load information indicating a load corresponding to number of requests processed by load distribution target computers as targets of load distributing by the load distributing device, the load distribution target computers including the server computers; and
the server configuration management unit determines an entire load of all load distribution target computers based on the computer load information acquired by the load information acquisition unit included in the load distributing device, and determines, based on the entire load of the all load distribution target computers, the number of provisioning computers, the use of which as the new load distribution target computers is to be started, or the use of which as the load distribution target computers is to be ended.

10. The load distributing system according to claim 6, wherein:
the server computers and the provisioning computers each include a load information acquisition unit configured to acquire computer load information indicating a load corresponding to a request which the server computers and the provisioning computers are each executing; and
the server configuration management unit determines an entire load of all load distribution target computers as targets of load distributing by the load distributing device, based on the computer load information acquired by load information acquisition units included in the all load distribution target computers, the all load distribution target computers including several of the server computers and the provisioning computers, the server configuration management unit determining, based on the entire load of the all load distribution target computers, the number of provisioning computers, the use of which as the new load distribution target computers is to be started, or the use of which as the load distribution target computers is to be ended.

11. The load distributing system according to claim 6, wherein:
the load distributing device includes a first load information acquisition unit configured to acquire first computer load information indicating a load corresponding to number of requests processed by load distribution target computers as targets of load distributing by the load distributing device, the load distribution target computers including the server computers;
the server computers and the provisioning computers each include a second load information acquisition unit configured to acquire second computer load information indicating a load corresponding to a request which the server computers and the provisioning computers are each executing; and
the server configuration management unit determines an entire load of all load distribution target computers based on the first computer load information acquired by the first load information acquisition unit included in the load distributing device, and determines, based on the entire load of the all load distribution target computers, first number of provisioning computers, use of which as the new load distribution target computers is to be started, or use of which as the load distribution target computers is to be ended, the server configuration management unit determining an entire load of all load distribution target computers as targets of load distributing by the load distributing device, based on the second computer load information acquired by the second load information acquisition units included in the all load distribution target computers, the all load distribution target computers including several of the server computers and the provisioning computers, the server configuration management unit determining, based on the entire load of the all load distribution target computers, second number of provisioning computers, use of which as new load distribution target computers is to be started, or use of which as load distribution target computers is to be ended, the server configuration management unit selecting one of the first number and the second number as number of provisioning computers based on the load of the all load distribution target computers, the use of the selected number of provisioning computers as the new load distribution target computers being to be started, or the use of the selected number of provisioning computers as the load distribution target computers being to be ended.

12. The load distributing system according to claim 6, further comprising:
a plurality of server sites each including the server computers, the load distributing device, the server configuration management unit and the setting change unit;
a provisioning site including the provisioning computers, the provisioning-computer management unit and the provisioning-computer start/stop unit; and
a network connecting the server sites to the provisioning site,
and wherein the server configuration management unit of each of the server sites determines, based on a load of all load distribution target computers in said each server site including the server computers, number of provisioning computers, use of which as new load distribution target computers is to be started in said each server site, or use of which as load distribution target computers is to be ended in said each server site; and
the provisioning-computer management unit determines provisioning computers corresponding to the number of provisioning computers determined by the server configuration management unit, use of the corresponding provisioning computers as the new load distribution target computers being to be started in said each server site, or use of the corresponding provisioning computers as the load distribution target computers being to be started in said each server site.

13. The load distributing system according to claim 12, wherein when the provisioning computers corresponding to the number of provisioning computers determined by the server configuration management unit of said each sever site are started or stopped, the provisioning-computer management unit of the provisioning site stores information indicating a start time or a stop time of the provisioning computers corresponding to the number of provisioning computers determined by the server configuration management unit of said each sever site, information indicating the provisioning computers corresponding to the number of provisioning computers determined by the server configuration management unit of said each sever site, and information indicating said each server site.

14. A load distributing method for use in a load distributing system, the load distributing system including a plurality of server computers which process requests from a plurality of client computers, a load distributing device which distributes the requests from the client computers between a plurality of load distribution target computers including the server computers, and a plurality of provisioning computers usable as load distribution target computers, the provisioning computers being started when the provisioning computers are used as the load distribution target computers, the method comprising:
determining number of provisioning computers, use of which as new load distribution target computers is to be started, or use of which as load distribution target computers is to be ended, based on a load of all load distribution target computers including the server computers;
determining provisioning computers corresponding to the determined number, when the number of provisioning computers, the use of which is to be started, is determined, the use of the corresponding provisioning computers as the new load distribution target computers being to be started;
starting the corresponding provisioning computers when the corresponding provisioning computers, the use of which is to be started, are determined;
adding the corresponding provisioning computers as load distribution target computers that are targets of load distribution by the load distributing device, when the corresponding provisioning computers, the use of which is to be started, are determined;
determining provisioning computers corresponding to the determined number, when the number of provisioning computers, the use of which is to be ended, is determined, the use of the corresponding provisioning computers as the load distribution target computers being to be ended;
stopping the corresponding provisioning computers when the corresponding provisioning computers, the use of which is to be ended, are determined; and
excluding the corresponding provisioning computers from load distribution target computers that are targets of load distribution by the load distributing device, when the corresponding provisioning computers, the use of which is to be ended, are determined.

15. The method according to claim 14, wherein:
the load distributing system includes a plurality of server sites each including the server computers and the load distributing device, a provisioning site including the provisioning computers; and a network connecting the server sites to the provisioning site;
the determining the number is executed in each of the server sites;
the determining the provisioning computers, the starting the provisioning computers and the stopping the provisioning computers are executed in the provisioning site; and
the method further comprising requesting, via the network, the provisioning site to start or end, in said each server site, the use of the provisioning computers corresponding to the determined number, when the number of provisioning computers is determined for said each server computer group, the use of the provisioning computers as the new load distribution target computers being to be started, or the use of the provisioning computers as the load distribution target computers being to be ended,
the determining the provisioning computers being executed in accordance with the request to start or end the use.

16. A load distributing method for use in a load distributing system, the load distributing system including a plurality of server computers which process requests from a plurality of client computers, a load distributing device which distributes the requests from the client computers between a plurality of load distribution target computers including the server computers, and a plurality of provisioning computers usable as load distribution target computers, the provisioning computers being started when the provisioning computers are used as the load distribution target computers, the server computers being managed, classified into a plurality of server computer groups corresponding to different types of boot images, the different types of boot images including operating systems executed by the server computers, the method comprising:
determining an entire load of each of the server computer groups based on a load of all load distribution target computers including the server computers of said each server computer group;
determining, for said each server computer group, number of provisioning computers, use of which as new load distribution target computers is to be started in said each server computer group, or use of which as load distribution target computers is to be ended in said each server computer group, based on the entire load of said each server computer group, when the entire load of said each server computer group is determined;
determining provisioning computers corresponding to the determined number, when the number of provisioning computers is determined for one of the server computer groups, use of the corresponding provisioning computers as new load distribution target computers being to be started in the one server computer group;
selecting, from the different types of boot images, a boot image corresponding to the one server computer group which includes the corresponding provisioning computers, when the corresponding provisioning computers, use of which is to be started in the one server computer group, are determined, the boot image being used to boot the determined provisioning computers;
starting the corresponding provisioning computers to boot the corresponding provisioning computers using the selected boot image, when the corresponding provisioning computers, the use of which is be started in the one server computer group, are determined, and when the boot image corresponding to the one server computer group is selected;
adding the corresponding provisioning computers as load distribution target computers that are targets of load distribution by the load distributing device, when the corresponding provisioning computers, the use of which is to be started in the one server computer group, are determined;
determining provisioning computers corresponding to the determined number, when the number of provisioning computers, use of which is to be ended in the one server computer group, is determined, the use of the corresponding provisioning computers as the load distribution target computers being to be ended in the one server computer group;
stopping the corresponding provisioning computers when the corresponding provisioning computers, the use of which is to be ended in the one server computer group, are determined; and
excluding the corresponding provisioning computers from load distribution target computers that are targets of load distribution by the load distributing device in the one server computer group, when the corresponding provisioning computers, the use of which is to be ended in the one server computer group, are determined.

17. The method according to claim 16, wherein:
the load distributing system includes a plurality of server sites each including the server computers and the load distributing device, a provisioning site including the provisioning computers; and a network connecting the server sites to the provisioning site;
the determining the load and the determining the number are executed in each of the server sites;
the determining the provisioning computers, the use of which is to be started, the selecting, the starting, the determining the provisioning computers, the use of which is to be ended, and the stopping are executed in the provisioning site; and
the method further comprising requesting, via the network, the provisioning site to start or end, in one of the server computer groups in said each server site, the use of the provisioning computers corresponding to the determined number, when the number of provisioning computers is determined, the use of which as the new load distribution target computers is to be started in the one server computer group, or the use of which as the load distribution target computers is to be ended in the one server computer group,
the determining the provisioning computers, the use of which is to be started, being executed in accordance with the request to start the use,
the determining the provisioning, the use of which is to be ended, computers being executed in accordance with the request to end the use.

18. A load distributing method for use in a load distributing system, the load distributing system including a plurality of server sites, a provisioning site and a network, each of the server sites including a plurality of server computers which process requests from a plurality of client computers, and a load distributing device which distributes the requests from the client computers between a plurality of load distribution target computers including the server computers, the server computers being managed, classified into a plurality of server computer groups corresponding to different types of boot images, the different types of boot images including operating systems executed by the server computers, the provisioning site including a plurality of provisioning computers usable as load distribution target computers, the provisioning computers being started when the provisioning computers are used as the load distribution target computers, the network connecting the server sites to the provisioning site, the method comprising:
determining an entire load of each of the server computer groups in each of the server sites, based on a load of all load distribution target computers including the server computers of said each server computer group;
determining, for said each server computer group in said each server site based on the entire load, number of provisioning computers, use of which as new load distribution target computers is to be started in said each server computer group in said each server site, or use of which as load distribution target computers is to be ended in said each server computer group in said each server site;
requesting, by said each server site via the network, the provisioning site to start, in one of the server computer groups in said each server site, use of provisioning computers corresponding to the determined number, when the number of provisioning computers is determined, the use of which is to be started in the one server computer group in said each server site;
adding provisioning computers, indicated by information, as load distribution target computers serving as targets of load distribution by the load distributing device, when the information is supplied from the provisioning site to said each server site, the information indicating that the provisioning computers, the use of which as the new load distribution target computers is to be started in the one server computer group in said each server site, are determined in accordance with a request to start the use issued from said each server site to the provisioning site, and then booted by one of the boot images corresponding to server computers belonging to the one server computer group; and
excluding provisioning computers, indicated by information, from the load distribution target computers as targets of load distribution by the load distributing device, when the information is supplied from the provisioning site to said each server site, the information indicating that the provisioning computers, the use of which as the load distribution target computers is to be ended in the one server computer group in said each server site, are determined in accordance with a request to end the use issued from said each server site to the provisioning site.

19. A load distributing method for use in a load distributing system, the load distributing system including a plurality of server sites, a provisioning site and a network, each of the server sites including a plurality of server computers which process requests from a plurality of client computers, and a load distributing device which distributes the requests from the client computers between a plurality of load distribution target computers including the server computers, the server computers being managed, classified into a plurality of server computer groups corresponding to different types of boot images, the different types of boot images including operating systems executed by the server computers, the provisioning site including a plurality of provisioning computers usable as load distribution target computers, the provisioning computers being started when the provisioning computers are used as the load distribution target computers, the network connecting the server sites to the provisioning site, the method comprising:
determining whether start of use or end of use is requested, when number of provisioning computers is determined for each of the server computer groups in said each server site, based on an entire load of said each server computer group in said each server site, based on a load of all load distribution target computers including the server computers of said each server computer group, and when a request to start to use provisioning computers corresponding to the determined number is issued from said each server site to the provisioning site via the network, use of the corresponding provisioning computers as new load distribution target computers being to be started in said each server computer group in said each server site, or use of the corresponding provisioning computers as load distribution target computers being to be ended in said each server computer group in said each server site;
determining the provisioning computers corresponding to the determined number, the use of which as load distribution target computers is to be started in said each server computer group in said each server site, when the start of use is requested;
selecting, from the boot images, a boot image corresponding to said each server computer group of said each server site, which includes the corresponding provisioning computers, when the corresponding provisioning computers, use of which is to be started as the load distribution target computers in said each server computer group of said each server site, are determined, the boot image being used to boot the corresponding provisioning computers;
starting the corresponding provisioning computers to boot the corresponding provisioning computers using the selected boot image, when the corresponding provisioning computers, the use of which is be started as the load distribution target computers in said each server computer group in said each server site, are determined, and when the boot image corresponding to said each server computer group is selected;
determining the provisioning computers corresponding to the determined number, the use of which as the load distribution target computers is to be ended in said each server computer group in said each server site, when the end of use is requested;
stopping the corresponding provisioning computers when the corresponding provisioning computers, the use of which is to be ended in said each server computer group in said each server site, are determined; and
supplying, from the provisioning site to said each server site, information indicating a result of processing performed in reply to the request to start the use or to end the use.
